(19) United States
(12) Patent Application Publication
(10) Pub. No.: US 2025/0317925 A1
(43) Pub. Date: Oct. 9, 2025

(54) CHANNEL CODING FOR PHYSICAL UPLINK SHARD CHANNEL (PUSCH)

(71) Applicant: SHARP KABUSHIKI KAISHA, Sakai City (JP)

(72) Inventors: Tomoki Yoshimura, Camas, WA (US); Zhanping Yin, Vancouver, WA (US)

(21) Appl. No.: 18/627,333

(22) Filed: Apr. 4, 2024

(51) Int. Cl. H04W 72/1268; H04L 1/00; H04W 76/20; H04W 84/06

(52) U.S. Cl. CPC H04W 72/1268; H04L 1/0067; H04W 76/20; H04W 84/06

(57) ABSTRACT

A UE includes computer-readable media storing instructions for coding of PUSCH and a processor. The processor is configured to determine several PUSCH repetitions. The processor selects a first RV sequence that includes a first group of unique RVs. If the UE is not configured to group the PUSCH repetitions, the processor applies a unique RV from the first group of unique RVs to each of the PUSCH repetitions. If the UE is configured to group the PUSCH repetitions, the processor groups the PUSCH repetitions into one or more groups of repetitions, expands the first RV sequence into a second RV sequence by repeating each unique RV of the first RV sequence a number of times in the second RV sequence, and applying a different RV from the second group of RVs to each group of PUSCH repetitions, such that the same RV is assigned to each of the group repetitions.

### TECHNICAL FIELD

The technology generally relates to wireless communications, and more particularly, to identifying and handling uplink transmission collisions.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5th generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to increase, however, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions for channel coding of physical uplink shared channel (PUSCH) and at least one processor coupled to the one or more non-transitory computer-readable media. The at least one processor is configured to execute the one or more computer-executable instructions to cause the UE to determine several PUSCH repetitions for an uplink (UL) PUSCH transmission of the UE; select a first redundancy version (RV) sequence to channel code the several PUSCH repetitions, the first RV sequence includes a first group of unique RVs; determine whether the UE is configured to group the several PUSCH repetitions into one or more groups of PUSCH repetitions; in a case that the UE is not configured to group the several PUSCH repetitions, apply a unique RV from the first group of unique RVs to each PUSCH repetition of the several PUSCH repetitions; and in a case that the UE is configured to group the several PUSCH repetitions: group the several PUSCH repetitions into one or more groups of PUSCH repetitions, each group of PUSCH repetitions includes a set of two or more PUSCH repetitions, expand the first RV sequence into a second RV sequence that includes a second group of RVs, where each unique RV of the first RV sequence is repeated a number of times in the second RV sequence, and apply a different RV from the second group of RVs to each group of PUSCH repetitions, such that a same RV is assigned to each of the set of two or more PUSCH repetitions of the group.

In an implementation of the first aspect, the number of times that each unique RV of the first RV sequence is repeated in the second RV sequence is based on a radio resource control (RRC) message received from a base station (BS).

In another implementation of the first aspect, grouping the several PUSCH repetitions into one or more groups includes applying orthogonal cover code (OCC) to the UL PUSCH transmission.

In another implementation of the first aspect, the number of times that each unique RV of the first RV sequence is repeated in the second RV sequence is based on a length of the OCC.

In another implementation of the first aspect, applying the OCC to the PUSCH transmission multiplexes the PUSCH transmission of the UE with a PUSCH transmission of one or more other UEs in time domain.

In another implementation of the first aspect, all PUSCH repetitions in each set of two or more PUSCH repetitions are required by a receiver to decode UL data carried by the set of two or more PUSCH repetitions.

In another implementation of the first aspect, the UL data carried by the set of two or more PUSCH repetitions includes first UL data for the PUSCH transmission of the UE and second UL data for a second PUSCH transmission of at least one other UE.

In another implementation of the first aspect, the UE and the at least one other UE transmit the first and second UL data to at least one satellite through a non-terrestrial network (NTN).

In another implementation of the first aspect, at least one RV in each of the first and second RV sequences includes several systematic bits carrying UL PUSCH data.

In another implementation of the first aspect, at least one RV in each of the first and second RV sequences includes several parity bits to provide reliability for decoding the PUSCH transmission by a receiver.

In another implementation of the first aspect, the at least one processor is configured to execute the one or more computer-executable instructions to cause the UE to store several coded bits in a circular buffer to perform a rate matching operation; and in the case that the UE is not configured to group the several PUSCH repetitions, further assign the coded bits in at least a portion of the circular buffer to the first group of RVs, and write the codded bits in the portion of the circular buffer that is assigned to the first RV sequence to an output sequence of the rate-matching operation.

In another implementation of the first aspect, a size of the circular buffer and a length of the output sequence of the rate-matching operation determine a number of parity bits written in the output sequence of the rate-matching operation.

In another implementation of the first aspect, the at least one processor is configured to execute the one or more computer-executable instructions to cause the UE to store several coded bits in a circular buffer to perform a rate matching operation; and in the case that the UE is configured to group the several PUSCH repetitions, further assign the coded bits in at least a portion of the circular buffer to the second group of RVs, and write the codded bits in the portion of the circular buffer that is assigned to the second RV sequence to an output sequence of the rate-matching operation.

In another implementation of the first aspect, a size of the circular buffer and a length of the output sequence of the rate-matching operation determine a number of parity bits written in the output sequence of the rate-matching operation.

In a second aspect, a method of channel coding of PUSCH is provided. The method includes determining several PUSCH repetitions for a UL PUSCH transmission of the UE; selecting a first RV sequence to channel code the several PUSCH repetitions, the first RV sequence includes a first group of unique RVs; determining whether the UE is configured to group the several PUSCH repetitions into one or more groups of PUSCH repetitions; in a case that the UE is not configured to group the several PUSCH repetitions, applying a unique RV from the first group of unique RVs to each PUSCH repetition of the several PUSCH repetitions; and in a case that the UE is configured to group the several PUSCH repetitions grouping the several PUSCH repetitions into one or more groups of PUSCH repetitions, each group of PUSCH repetitions includes a set of two or more PUSCH repetitions, expanding the first RV sequence into a second RV sequence that includes a second group of RVs, where each unique RV of the first RV sequence is repeated a number of times in the second RV sequence, and applying a different RV from the second group of RVs to each group of PUSCH repetitions, such that a same RV is assigned to each of the set of two or more PUSCH repetitions of the group.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIGS. 2A and 2B are two diagrams illustrating parameters related to subcarrier spacing (SCS)-specific carriers, according to an example implementation of the present disclosure.

FIG. 3 is a diagram illustrating an example configuration of SCS-specific carriers, according to an example implementation of the present disclosure.

FIG. 4 is a diagrammatic view illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure.

FIG. 8 is a time-frequency diagram illustrating an example resource partitioning in a serving cell, according to an example implementation of the present disclosure.

FIG. 9 is a time-frequency diagram illustrating an example PUSCH allocation in a serving cell, according to an example implementation of the present disclosure.

FIG. 10 is a diagram illustrating an example of a circular buffer for a rate-matching operation, according to an example implementation of the present disclosure.

FIG. 11 is a time-frequency diagram illustrating an example of handling of a collision of a PUCCH with a PUSCH when the OCC is not applied to the PUSCH, according to an example implementation of the present disclosure.

FIG. 12 is a time-frequency diagram illustrating an example of the PUSCH repetitions, according to an example implementation of the present disclosure.

FIG. 13 is a time-frequency diagram illustrating an example of a collision of a PUCCH with a PUSCH repetition, according to an example implementation of the present disclosure.

FIG. 14 is a time-frequency diagram illustrating an example of the collision of a PUCCH with a PUSCH repetition in a case that the OCC is applied to the PUSCH repetitions, according to an example implementation of the present disclosure.

FIG. 15 is a flowchart of an example method/process performed by a UE for dropping the PUCCH and foregoing the transmission of the UCI in a case that the OCC is applied to the PUSCH repetitions and the PUCCH collides with one of the PUSCH repetitions, according to an example implementation of the present disclosure.

FIG. 16 is a time-frequency diagram illustrating an example of grouping the PUSCH repetitions into several groups of repetitions, according to an example implementation of the present disclosure.

FIG. 17 is a time-frequency diagram illustrating an example of providing the UE with a timeline threshold to determine whether all PUSCH repetitions should be dropped in a case that the OCC is applied to the PUSCH repetitions and there is a collision between a PUCCH and one of the PUSCH repetitions, according to example an implementation of the present disclosure.

FIG. 18 is a flowchart of an example method/process performed by a UE for dropping all PUSCH repetitions in a case that the OCC is applied to the PUSCH repetitions and a PUCCH collides with one of the PUSCH repetitions, according to an example implementation of the present disclosure.

FIG. 19 is a flowchart of an example method/process performed by a UE for dropping the PUCCH and piggybacking the transmission of the UCI of the PUCCH on the PUSCH repetitions in a case that the OCC is applied to the PUSCH repetitions and the PUCCH collides with one of the PUSCH repetitions, according to an example implementation of the present disclosure.

FIG. 20 is a diagram illustrating an example of a circular buffer for rate-matching operation, according to an example implementation of the present disclosure.

FIG. 21 is a time-frequency diagram illustrating an example of grouping the PUSCH repetitions into several groups of repetitions and mapping the RVs to the repetitions, according to an example implementation of the present disclosure.

FIG. 22 is an example diagram illustrating a table that defines the RV allocation for the n^{th} PUSCH repetition, according to an example implementation of the present disclosure.

FIG. 23 is a flowchart of an example method/process performed by a UE for channel coding of PUSCH, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3rd Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in an RRC_CONNECTED state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

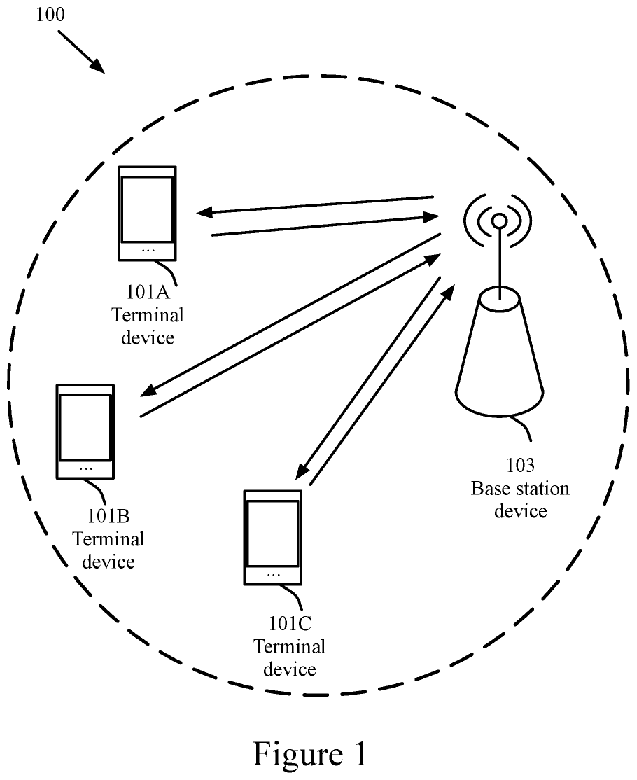

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 is configured of multiple transmission/reception devices, each of the multiple transmission/reception devices may be arranged at a different position. A transmission/reception device may include a transmission device and/or a reception device.

BS 103 may serve radio communication and provide one or more cells. A cell is defined as a set of resources used for a wireless communication. A cell may include one or both of a downlink component carrier and an uplink component carrier. A serving cell may include a downlink component carrier and two or more uplink component carriers.

One or more SCS-specific carriers may be associated with one component carrier. Each SubCarrier Spacing-specific (SCS-specific) carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier.

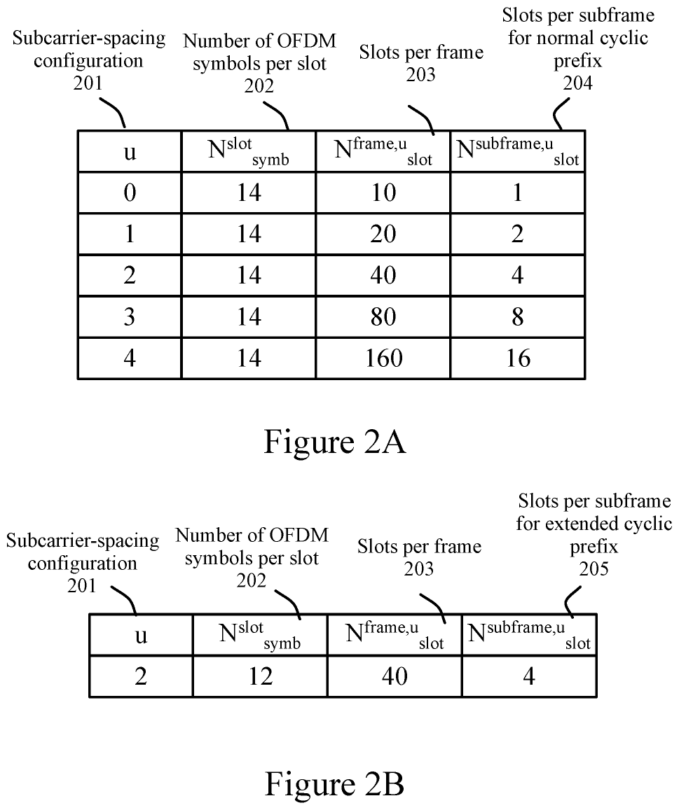

FIGS. 2A and 2B are two diagrams illustrating parameters related to subcarrier spacing (SCS)-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame, u}ₛₗₒₜ 203 represents the number of slots in a radio frame. N^{subframe, u}ₛₗₒₜ 204 and N^{subframe, u}ₛₗₒₜ 205 represent the number of slots in a subframe for normal cyclic prefix and extended cyclic prefix, respectively.

In FIG. 2A, for example, when the subcarrier-spacing configuration u 201 is set to 2 and the CP configuration is set to normal Cyclic Prefix CP), the parameters are set to N^{slot}_{symb}=14, N^{frame, u}ₛₗₒₜ=40, and N^{subframe, u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame, u}ₛₗₒₜ=40, N^{subframe, u}ₛₗₒₜ=4.

Time unit T_{c} represents the length of the time domain. The time unit T_{c} may be calculated by 1/(dfₘₐₓ*N_{f}), where dfₘₐₓ represents 480 kHz and N_{f}=4096. The constant k may be calculated by dfₘₐₓ*N_{f}/(d_{fre}fN_{f, ref}). The constant k is 64 when df_{ref} is 15 kHz and N_{f, ref} is 2048.

Radio transmissions in the downlink and/or radio transmissions in the uplink may be organized into radio frames (or system frames, frames) of length T_{f}. T_{f} is calculated by (dfₘₐₓN_{f}/100)*Tₛ and (dfₘₐₓN_{f}/100)*Tₛ is equal to 10 ms. One radio frame may include ten subframes. The subframe length T_{sf} is calculated by dfₘₐₓN_{f}Tₛ/1000 and dfₘₐₓN_{f}Tₛ/1000 is equal to 1 ms. The number of OFDM symbols per subframe N^{subframe, u}_{symb} is calculated by N^{slot}_{symb}N^{subframe, u}ₛₗₒₜ.

SCS of the OFDM-based waveform may be calculated by subcarrier-spacing configuration u. For example, the SCS may be calculated by 15000*2^{u}.

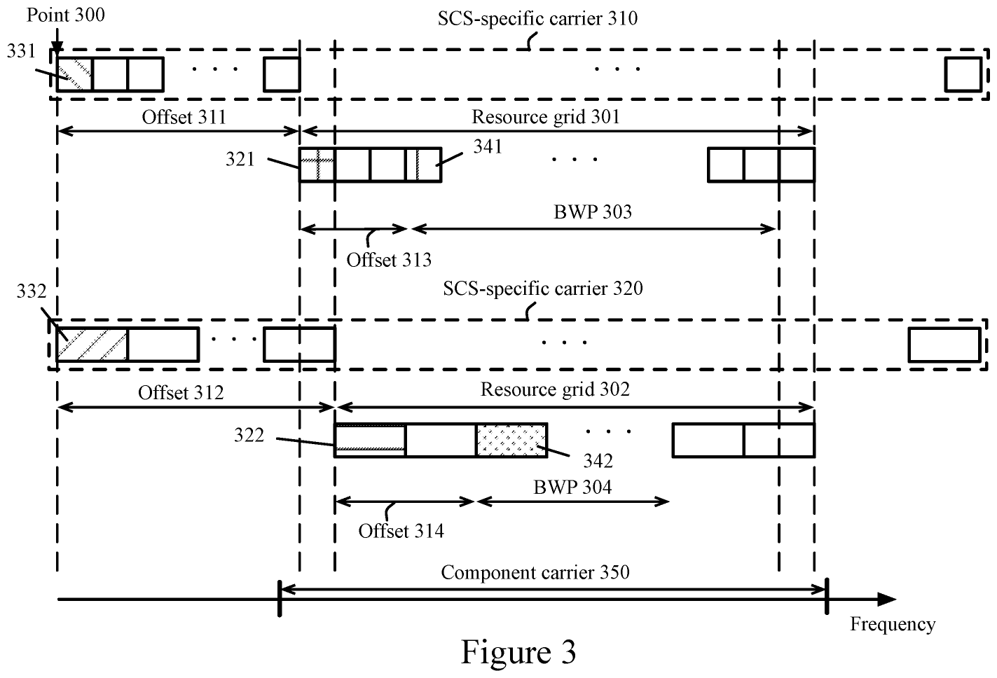

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed.

Point 300 is an identifier for a specific subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point 300.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. The reference point of the BWP 303 is the block 341. The offset 314 is an RB-level offset from the reference point 322 of the resource grid 301 to the reference point 342 of the BWP 304. The reference point of the BWP 304 is the block 342.

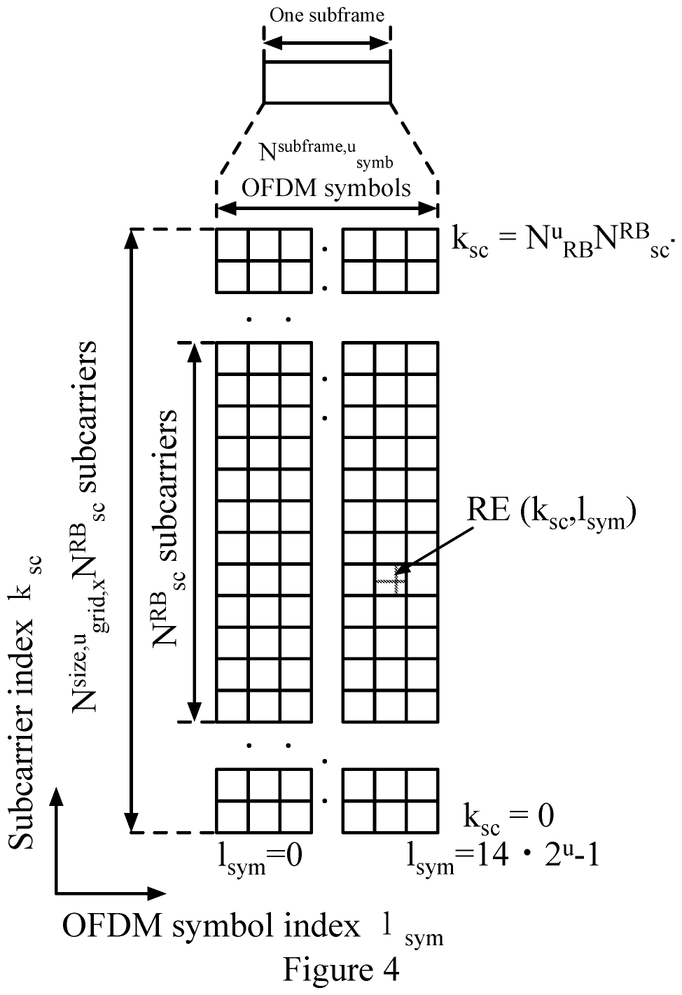

FIG. 4 is a diagrammatic view illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid,x}N^{RB}_{sc} subcarriers and N^{subframes,u}_{symb} OFDM symbols. A resource specified by the subcarrier index k_{sc} and the OFDM symbol index l_{sym} in a resource grid is also referred to as (Resource Element (RE).

A resource block (RB) includes N^{RB}_{sc} consecutive subcarriers. A resource block is a generic name for a CRB, a Physical Resource Block (PRB), and/or a Virtual Resource Block (VRB). In FIG. 4, N^{RB}_{sc} may be 12. CRBs are indexed in ascending order starting at CRB with index 0. PRBs are indexed in ascending order starting at its reference point of the BWP. A BWP is defined as a subset of resource blocks included in the resource grid. The BWP includes N^{size, u}_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

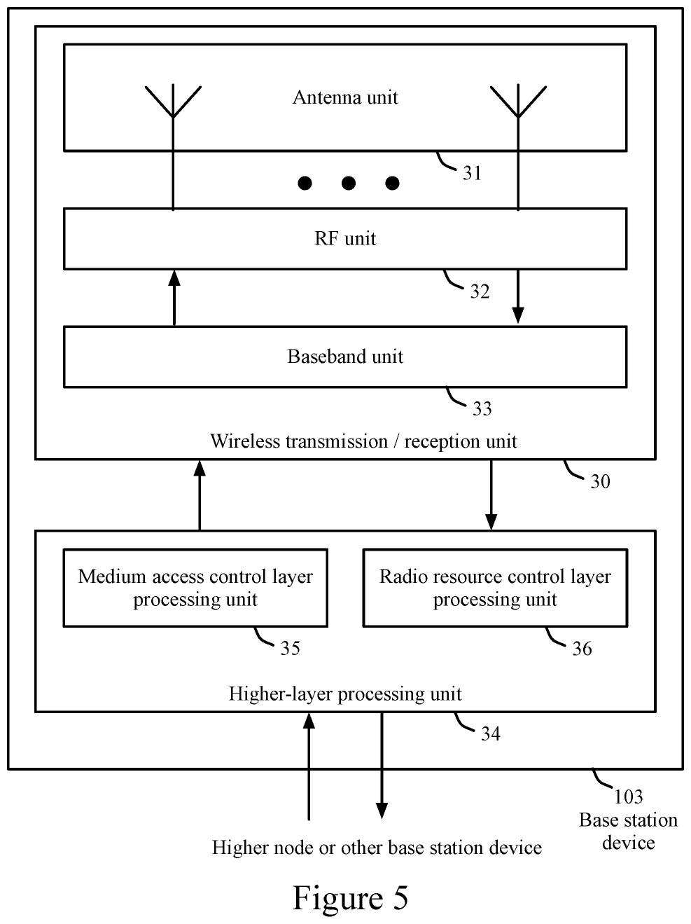

FIG. 5 is a schematic block diagram illustrating a configuration example of a base station device 103, according to an example implementation of the present disclosure. As shown in FIG. 5, the base station device 103 may include a part or all of the wireless transmission and reception unit (also referred to herein as physical layer processing unit) 30 and a higher-layer processing unit 34. The wireless transmission and reception unit 30 may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

The terminal device 101 may configure one or more downlink BWPs per serving cell. The terminal device 101 may configure one or more uplink BWPs per serving cell.

The terminal device 101 may try to detect a Physical Downlink Shared Channel (PDSCH), a Physical Downlink Control Channel (PDCCH), and a Channel State Information-Reference Signal (CSI-RS) in the active downlink BWP. The terminal device 101 may transmit a Physical Uplink Control Channel (PUCCH) and a Physical Uplink Shared Channel (PUSCH) in the active uplink BWP. The active downlink BWP and the active uplink BWP are also referred to as active BWP.

The terminal device 101 may not receive the PDSCH, PDCCH, and CSI-RS in the downlink BWPs other than the active downlink BWP. The terminal device 101 may not transmit the PUCCH and PUSCH in the uplink BWPs other than the active uplink BWP. BWPs other than the active BWP is referred to as inactive BWPs.

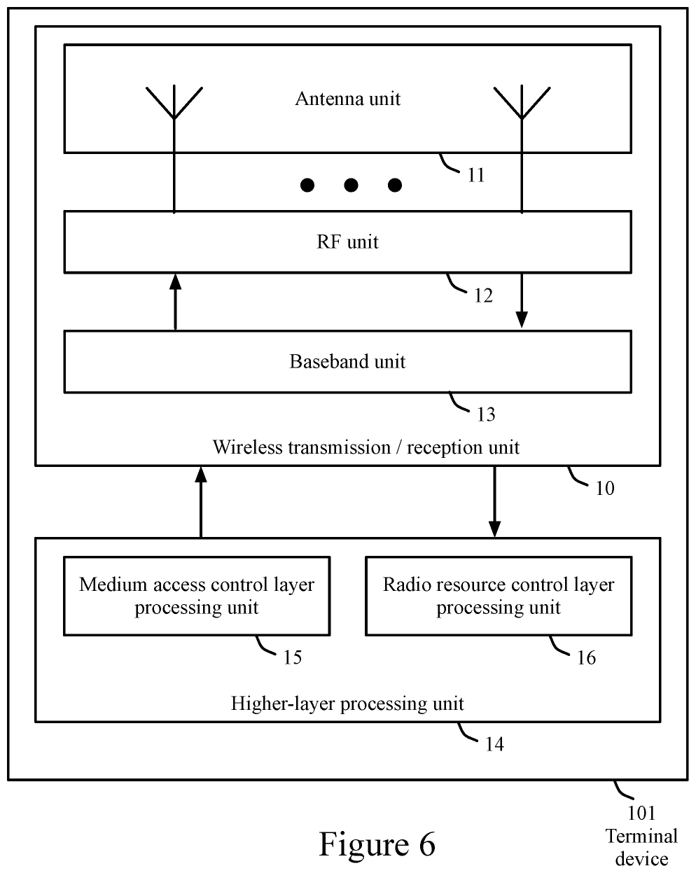

FIG. 6 is a schematic block diagram illustrating a configuration example of a terminal device, according to an example implementation of the present disclosure. As shown in FIG. 6, the terminal device 101 may include a part or all of the wireless transmission and reception unit (also referred to herein as physical layer processing unit) 10 and the higher-layer processing unit 14. The wireless transmission and reception unit 10 may include a part or all of the antenna unit 11, the RF unit 12, and the Baseband unit 13. The higher-layer processing unit 14 may include a part or all of the MAC layer processing unit 15 and the RRC layer processing unit 16. The higher-layer processing unit 14 may include at least one processor (not shown in the figure) and one or more non-transitory computer-readable media (not shown in the figure) that store computer-executable instructions and data.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 may perform processing of the MAC layer, the PDCP layer, the RLC layer, and/or the RRC layer.

The MAC layer processing unit 15 in the higher-layer processing unit 14 may perform processing of the MAC layer. RRC layer processing unit 16 in the higher-layer processing unit 14 may perform the process of the RRC layer. RRC layer processing unit 16 manages various RRC parameters of the terminal device 101 based on RRC messages received from the base station device 103.

The wireless transmission and reception unit 10 (or the wireless transmission unit 10a) may perform processing, such as encoding and modulation. The wireless transmission and reception unit 10 (or the wireless transmission unit 10a) may generate a physical signal by encoding and modulating the uplink data. The wireless transmission and reception unit 10 (or the wireless transmission unit 10a) may convert OFDM symbols in the physical signal to a baseband signal by conversion to a time-continuous signal. The wireless transmission and reception unit 10 (or the wireless transmission unit 10a) may transmit the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) may separate, demodulate, and decode the received physical signal, and provide the decoded information to the higher-layer processing unit 14. The wireless transmission and reception unit 10 (or the wireless reception unit 10b) may perform the channel access procedure prior to the transmission of the physical signal.

The RF unit 12 may demodulate the radio signal received via the antenna unit 11 into an analog signal, and/or removes extra frequency components. The RF unit 12 may provide the processed analog signal to the baseband unit 13. The baseband unit 13 may convert the analog signal input from RF unit 12 into a baseband signal. The baseband unit 13 may separate a portion which corresponds to CP from the baseband signal, perform FFT on the baseband signal from which the CP has been removed. The baseband unit 13 may extract components of the physical signal from the baseband signal.

The baseband unit 13 may perform IFFT on the uplink data to generate time-continuous signal, adds a CP to the generated signal, generate a baseband signal, and convert the baseband signal into an analog signal. The baseband unit 13 may provide the analog signal to the RF unit 12.

The RF unit 12 may remove extra frequency components from the analog signal input from the baseband unit 13, up-converts the analog signal to a radio frequency, and may transmit it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the radio communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access preamble. A PRACH may be sent to deliver (transmit, convey) an index of a random-access preamble. the terminal device 101 may transmit a PRACH. The base station device 103 may receive the PRACH.

For a given PRACH opportunity, 64 random-access preambles are defined. The random-access preamble is specified (determined, given) based on the cyclic shift Cv of the PRACH and the sequence index u for the PRACH.

A physical uplink signal corresponds to a set of REs. A physical uplink signal may not carry information generated in the higher-layer. The terminal device 101 may transmit a physical uplink signal. The base station device 103 may receive the physical uplink signal. In the radio communication system according to one aspect of the present embodiment, a part or all of UpLink Demodulation Reference Signal (UL DMRS), SRS (Sounding Reference Signal (SRS), UpLink Phase Tracking Reference Signal (UL PTRS) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and Downlink Control Information (DCI). In the radio communication system according to one aspect of the present embodiment, a part or all of Physical Broadcast Channel (PBCH), Physical Downlink Control Channel (PDCCH), and Physical Downlink Shared Channel (PDSCH) may be used.

A PBCH may be used to transmit a Master Information Block (MIB). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

DCI format includes a set of information fields. Each information field may mask a bit sequence of the DCI. Bits masked by an information field is associated with a specific meaning associated with the information field.

Several DCI formats may be used in the radio communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a Frequency Domain Resource Assignment (FDRA) field. Information field 1C is a Time Domain Resource Assignment (TDRA) field. Information field 1D is a frequency-hopping flag field. Information field 1E is a Modulation-and-Coding-Scheme (MCS) field.

A DCI format identification field may indicate whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format may be used to indicate assignment of frequency resources for a physical channel scheduled by the DCI format. For example, the FDRA field may indicate the number of RBs, X, for PUSCH.

A TDRA field in a DCI format may be used to indicate assignment of time resources for a physical channel scheduled by the DCI format.

A frequency-hopping flag field in a DCI format may be used to indicate whether frequency-hopping is applied to a physical channel scheduled by the DCI format.

A MCS field in a DCI format may be used to indicate one or both of a modulation scheme for a physical channel scheduled by the DCI format and a target code rate for the physical channel. The target code rate is used to determine a Transport Block Size (TBS) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 may determine that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 may determine that active BWP change has not been triggered by the DCI format.

DCI format 0_1 may be used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 0_1 may indicate that the DCI format 0_1 is an uplink DCI format.

The CSI request field may be used to request CSI reporting.

If the DCI format 0_1 includes a BWP field, the BWP field may be used to indicate an uplink BWP on which a PUSCH scheduled by the DCI format 0_1 is mapped.

If the DCI format 0_1 includes the carrier indicator field, the carrier indicator field may be used to indicate an uplink component carrier on which a PUSCH is mapped.

DCI format 1_0 may be used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field may be used to indicate a PUCCH resource.

The DCI format 1_0 may not include the carrier indicator field. If a downlink DCI format does not include the carrier indicator field, the terminal device 101 may determine that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 may be used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 1_1 may indicate that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher-layer. The base station 103 transmits a physical downlink signal. The terminal device 101 may receive the physical downlink signal. In the radio communication system according to one aspect of the present embodiment, at least a part or all of a Synchronization signal (SS), DownLink DeModulation Reference Signal (DL DMRS), (Channel State Information-Reference Signal (CSI-RS), and DownLink Phase Tracking Reference Signal (DL PTRS) may be used.

A synchronization signal may be used to synchronize in the frequency domain and time domain for downlink. The synchronization signal is a generic name of PSS (Primary Synchronization Signal) and SSS (Secondary Synchronization Signal).

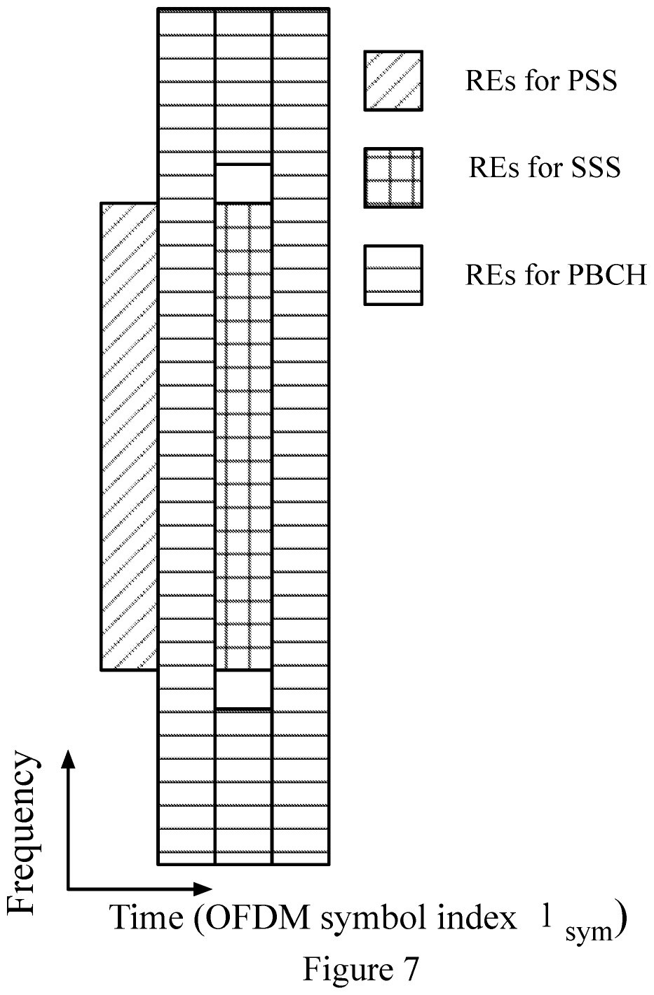

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index l_{sym}, and the vertical axis represents the frequency domain. The shaded blocks represent a set of REs for the PSS. The block of grid lines represents a set of REs for the SSS. Also, the blocks in the horizontal line represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block may be identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A BCH (Broadcast CHannel), a UL-SCH (Uplink-Shared CHannel) and a DL-SCH (Downlink-Shared CHannel) are transport channels. A channel used in the MAC layer is called a transport channel. A unit of transport channel used in the MAC layer is also called transport block (TB) or MAC PDU (Protocol Data Unit). In the MAC layer, control of HARQ (Hybrid Automatic Repeat request) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A BCCH (Broadcast Control CHannel), a CCCH (Common Control CHannel), and a DCCH (Dedicated Control CHannel) are logical channels. The BCCH is a channel of the RRC layer used to deliver MIB or system information. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The base station device 103 may indicate change of cell-specific parameters by reconfiguration with random-access. The base station device 103 may indicate change of UE-specific parameters by reconfiguration with or without random-access.

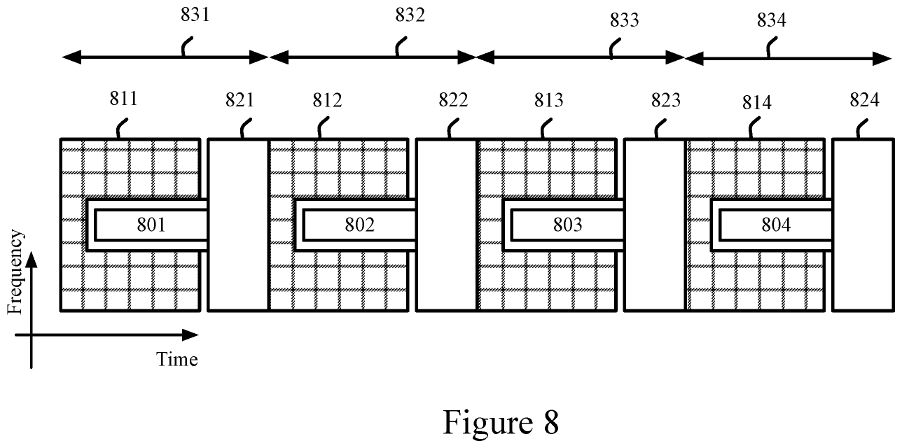

FIG. 8 is a time-frequency diagram illustrating an example resource partitioning in a serving cell, according to an example implementation of the present disclosure. The horizontal axis represents the time domain. The vertical axis represents the frequency domain. The regions 801, 802, 803, and 804 represent the time-frequency resources for a UL subband. The regions 811, 812, 813, and 814 with grid lines represent DL regions. The regions 821, 822, 823, and 824 represent UL regions. The lines 831, 832, 833, and 834 represent periods of the time division duplexing (TDD) pattern. Each region represents a resource for each SS/PBCH block with a different index. Time domain guard periods are placed on a switching location from DL to UL. Frequency domain guard bands are placed on a boundary of DL and UL.

TDD pattern is a pattern including a part of all the DL region, flexible region, and UL region. In FIG. 8, the TDD pattern includes the DL region and the UL region. The time domain guard period between the DL region and UL region may be as part of the DL region, as part of the UL region, or flexible region. The TDD pattern may be configured based on one or more RRC parameters provided by the RRC layer.

The UL subband may be configured in one or both of the DL region and the time domain guard period. The time domain resource of the UL subband may be configured by one or more RRC parameters provided by the RRC layer.

The time domain resource of the UL subband may be configured by one or more first RRC parameters used to indicate a periodicity of the UL subband, one or more second RRC parameters used to indicate the starting slot of the UL subband in each period, and one or more third RRC parameters used to indicate the length of the UL subband in each period in number of slots. For example, in a case that the periodicity is 20 slots, the starting slot is the 3^{rd} slot, and the length is 11 slots, the terminal device 101 determines that the UL subband with length of 11 slots starting at the 3^{rd} slot is placed in each periodicity.

One or more first RRC parameters used to indicate the periodicity may be one or more RRC parameters different from the one or more RRC parameters used to indicate the periodicity of the TDD pattern. For example, the one or more RRC parameters used to indicate the periodicity of the TDD pattern may be reused to indicate the periodicity of the UL subband. For example, the terminal device 101 may assume the periodicity of the UL subband is the same as the periodicity of the TDD pattern.

One or more fourth RRC parameters may be used to indicate the starting OFDM symbol of the UL subband in the starting slot. For example, one or more fifth RRC parameters may be used to indicate the length of the UL subband in number of symbols. For example, the frequency domain resource of the UL subband may be configured by one or more first RRC parameters used to indicate the starting RB of the UL subband and one or more second RRC parameters used to indicate the length of the UL subband in number of RBs.

The UL subband may be configured in an SCS-specific carrier. Therefore, in this case, the RRC parameters used to indicate resources of the UL subband may be provided per SCS-specific carrier. The UL subband may be configured in a BWP. Therefore, in this case, the RRC parameters used to indicate resources of the UL subband may be provided per BWP.

Using the UL subband, the base station device 103 may perform simultaneous transmission and reception at a time. For example, in a time occasion with UL subband 801, the base station device 103 performs transmission of physical downlink channels in the region 811 and reception of physical uplink channels in the region 801 at a time. The time occasion where the UL subband is mapped is referred to as a SubBand Full Duplex (SBFD) region.

Various physical layer configurations may be independently provided for the SBFD region and non-SBFD region. For example, the base station device 103 may use different QCL properties for the SBFD region and the non-SBFD region. The base station device 103 may use different settings for the components of the RF unit 32. For example, the components may include analog filters, amplifiers, or clocks. The terminal device 101 may obtain information related to the various physical layer configurations from the base station device 103.

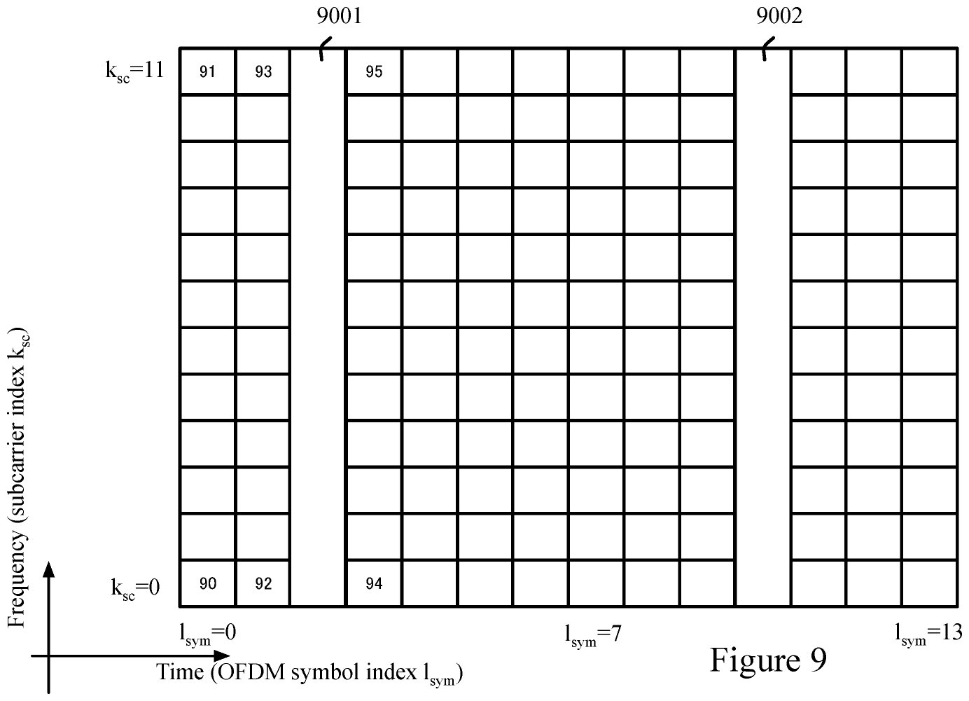

FIG. 9 is a time-frequency diagram illustrating an example PUSCH allocation in a serving cell, according to an example implementation of the present disclosure. The horizontal axis represents the OFDM symbol index, and the vertical axis represents the subcarrier index. A PUSCH may be allocated in 12 subcarriers and 14 OFDM symbols. Resource elements may be identified by the index set (k_{sc}, l_{sym}). For example, the resource element 90 has index set (0, 0), the resource element 91 has index set (11, 0), the resource element 92 has index set (0, 1), the resource element 93 has index set (11, 1), the resource element 94 has index set (0, 3), and the resource element 95 has index set (11, 3). In FIG. 9, single layer transmission is assumed for simplicity. Embodiments and modes are also applicable to multi-layer transmission.

A sequence of modulation symbols x₁ may be mapped to the resource elements in the PUSCH allocation. Here, each of the modulation symbols x₁ may be a complex valued symbol derived by modulation (e.g., Quadrature Phase Shift Keying (QPSK), 16 Quadrature Amplitude Modulation (QAM), 64 QAM, 256 QAM, 1024 QAM). In some embodiments, each of the modulation symbols x₁ may be a complex valued symbol derived at least from modulation and precoder.

The length L of the sequence of the modulation symbols x₁ may be derived by the number of resource elements excluding resource elements (e.g., 9001 and 9002) reserved for other purposes. In the example described in FIG. 9, L is equal to 12*12=144.

The sequence of the modulation symbols x₁ may be mapped to the resource elements allocated for the PUSCH transmission in the frequency-first manner. In some embodiments, x₀ may be mapped to the resource element with index set (0, 0), x₁ may be mapped to the resource element with index set (1, 0), and x₂ may be mapped to the resource element with index set (2, 0), and so on. Furthermore, x₁₁ may be mapped to the resource element with index set (11, 0), x₁₂ may be mapped to the resource element with index set (0, 1), and x₁₃ may be mapped to the resource element with index set (1, 1), and so on. On the other hand, the modulation symbols may not be mapped to some resource elements reserved for other purposes (e.g., resource elements 9001-9002 reserved for DMRS of the PUSCH). Therefore, x₂₃ may be mapped to the resource element with index set (11, 1), x₂₄ may be mapped to the resource element with index set (0, 3), and x₂₅ may be mapped to the resource element with index set (1, 3), and so on.

An Orthogonal Cover Code (OCC) may be applied to a PUSCH. OCC is a coding technique used to mitigate interference and improve system performance. By assigning orthogonal codes to different subchannels, the OCC allows for simultaneous and interference-free transmission of multiple users' data, making it possible for multiple UEs to share multiple UL resources. In a case where an OCC is applied to a PUSCH, modulation symbols may apply spreading. In a case where an OCC of {p₀, p₁} is applied to a PUSCH, the wireless transmission and reception unit 30 (FIG. 5) may generate two different sequences of p₀*x₁ and p₁*x₁. Here, p₀ and p₁ are complex valued symbols.

In some implementations, OCC may be applied before transform precoding. If an OCC is applied to a PUSCH before transform precoding, the OCC may be seen as interleaved frequency division multiplex.

In some embodiments, the two sequences may be mapped to the resource elements allocated for the PUSCH. For example, p₀*x₀ may be mapped to the resource element with index set (0,0), p₁*x₀ may be mapped to the resource element with index set (1,0), p₀*x₁ may be mapped to the resource element with index set (2,0), and p₁*x₁ may be mapped to the resource element with index set (3,0), and so on. In this example, p₀*x₁ and p₁*x₁ are mapped next to each other in the frequency domain. This kind of mapping is referred to as frequency domain OCC.

In some embodiments, p₀*x₀ may be mapped to the resource element with index set (0,0), p₁*x₀ may be mapped to the resource element with index set (0,1), p₀*x₁ may be mapped to the resource element with index set (1,0), and p₁*x₁ may be mapped to the resource element with index set (1,1), and so on. In this example, p₀*x₁ and p₁*x₁ are mapped next to each other in the time domain. This kind of mapping is referred to as time domain OCC.

The length of OCC is referred to as a spreading factor. The spreading factor of the OCC of {p₀, p₁} is 2.

In a case where OCC with spreading factor P is applied to the PUSCH, the length of the sequence of the modulation symbols x₁ may be represented by the number of resource elements allocated for the PUSCH excluding resource elements reserved for other purposes (e.g., resource elements 9001-9002), divided by the spreading factor. For example, in a case where the spreading factor is 2 and the PUSCH allocation as in FIG. 9, the length of the sequence is 144/2=72.

In a case where the length of the sequence of the modulation symbols x₁ is divided by the spreading factor, rate-matching output sequence length may be also divided by the spreading factor where the rate-matching output sequence length is derived by the length of the sequence of the modulation symbols x₁ multiplied by the modulation order of the modulation type.

As an example, in a Single-Input Single-Output (SISO) system, the signal received from two UEs (e.g., UE 0 and UE 1) at the receiver may be represented as r₀=p₀₀s₀+p₁₀s₁ and r₁=p₀₁s₀+p₁₁s₁, where p₀=[p₀₀, p₀₁]^{T} and p₁=[p₁₀, p₁₁]^{T} are the pair of the OCC sequences, and T denotes the vector transpose operation. The two sequences are, therefore, orthogonal. That is, p₀₀*p′₁₀+p₀₁*p′₁₁=0, where p′ is the conjugate of p, and T represents the transpose of the vector, s₀ is the transmitted data from the UE 0, and s₁ is the transmitted data from UE 1. Therefore, the transmissions from the two UEs may be multiplexed using the OCC and the time-frequency resource of the repetition 0 and repetition 1.

The receiver may multiply the OCC to the received signal vector r=[r₀, r₁]^{T}. For example, to extract the data so, the receiver may perform p^{H}₀*r=p′₀₀*(p₀₀s₀+p₁₀s₁)+p′₀₁*(p₀₁s₀+p₁₁s₁)=|p₀₀|²*s₀+|p₀₁|²*s₀+p′₀₀*p₁₀s₁+p′₀₁*p₁₁s₁, where p^{H}₀ denotes the conjugate of p₀. The norm of the OCC sequence may be designed to be 1. In this case, |p₀₀|²*s₀+|p₀₁|²*s₀=s₀. Furthermore, using the orthogonality of the OCC sequences, p′₀₀*p₁₀s₁+p′₀₁*p₁₁s₁=0. Therefore, p^{H}₀*r=s₀. To extract (or decode) the desired signal from the signal transmitted by the two UEs using the OCC, the receiver has to receive both repetition 0 and repetition 1.

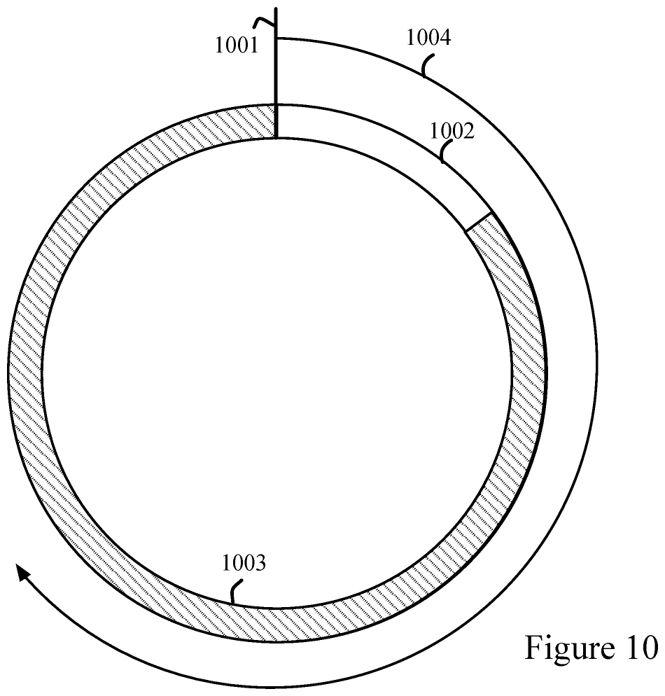

FIG. 10 is a diagram illustrating an example of a circular buffer for a rate-matching operation, according to an example implementation of the present disclosure. The circular buffer shows concept of the rate-matching operation. In the circular buffer, coded bits (e.g., bits encoded by an error correcting code) may be mapped in clockwise order. Here, 1001 represents the starting position of the coded bit mapping. The section 1002 represents the part of the circular buffer used to store systematic bits of the coded bits. The section 1003 represents the part of the circular buffer used to store parity bits of the coded bits. The region 1004 represents the region where the coded bits in the circular buffer are written into the output sequence of the rate-matching operation. The length of the output sequence may be used to determine the rate-matching output sequence length.

The size of the circular buffer and the rate-matching output sequence length may determine how many parity bits are written into the output sequence of the rate-matching operation. If the size of the circular buffer is unchanged and the rate-matching output sequence is shortened, the number of parity bits written into the output sequence may be reduced. The reduction of the parity bits may cause degraded decoding performance. Furthermore, If the output sequence does not include any parity bits, the receiver cannot decode the data.

I. Handling UL Transmission Collisions when OCC is Applied

Some embodiments solve collision issues of the PUCCH and PUSCH in a case that the OCC is applied to the PUSCH. The collision of the PUCCH and PUSCH has been a problem from the LTE network architecture. In the LTE and NR, the PUCCH and PUSCH are designed to have a single carrier property. For example, in some PUCCH formats and PUSCH formats, Zadoff-Chu (ZC) sequence has been employed, which preserves single carrier property and, therefore, may yield low Peak to Average Power Ratio (PAPR) characteristics. For some other PUCCH formats and for PUSCH formats, DFT-s-OFDM have been employed, which also preserves the single carrier property.

However, if two single carrier signals overlap at time domain, the collided signals no longer yield the single carrier property. Since the transmission power of a UE may be limited, the power required for the simultaneous transmission of the PUSCH and PUCCH may exceed the transmission power of the UE. Therefore, to preserve the single carrier property, one of the PUCCH or PUSCH has to be dropped.

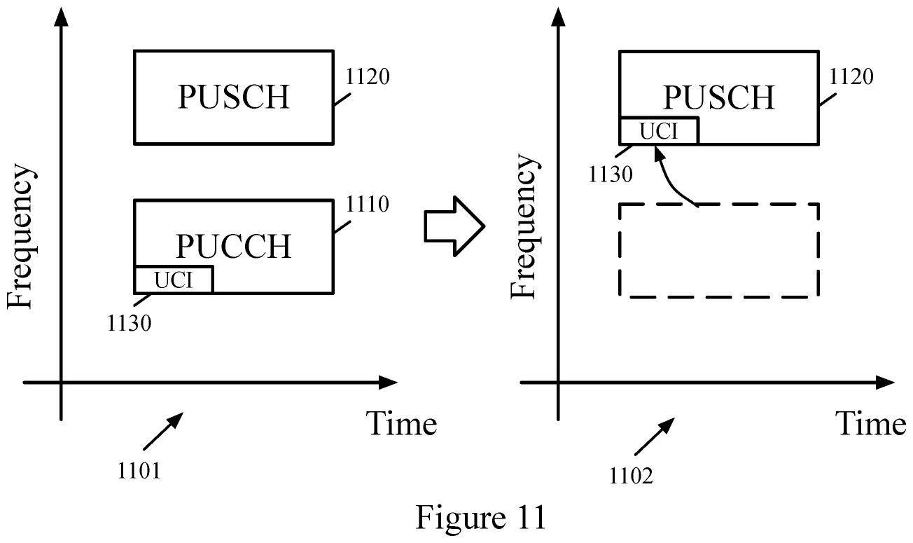

FIG. 11 is a time-frequency diagram illustrating an example of handling a collision of a PUCCH with a PUSCH when the OCC is not applied to the PUSCH, according to an example embodiment of the present disclosure. FIG. 11 includes two operational stages 1101 and 1102. The stage 1101 shows the collision of a PUCCH 1110 and a PUSCH 1120 in the time domain. The PUCCH 1110 and the PUSCH 1120 may be placed in different frequencies. The UCI 1130 may be expected to be transmitted via PUCCH 1110.

In the stage 1102, the PUCCH may be dropped. As shown, the UCI 1130 that was expected to be transmitted via PUCCH 1110 may be piggybacked on the PUSCH 1120. This operation is referred to as the UCI piggyback on the PUSCH. The reason why the PUCCH is dropped is because the time-frequency resource of the PUCCH is usually smaller than the PUSCH.

In some implementations, the PUSCH transmission may include repetitions. Repetition transmission is a technique for achieving a better coverage area by the BS by incrementing the time frequency resource of the PUSCH. The PUSCH repetitions may be used, for example, in non-terrestrial networks (NTNs) that may include satellites.

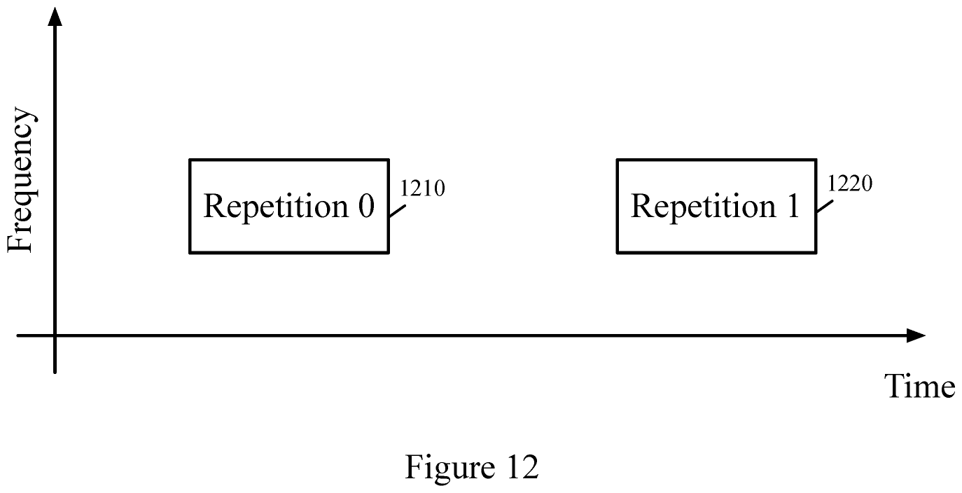

FIG. 12 is a time-frequency diagram illustrating an example of the PUSCH repetitions, according to an example embodiment of the present disclosure. As shown by the repetitions 1210 and 1220, a PUSCH with the same amount of time-frequency resource may be repeated twice (or more) in order to achieve a better coverage.

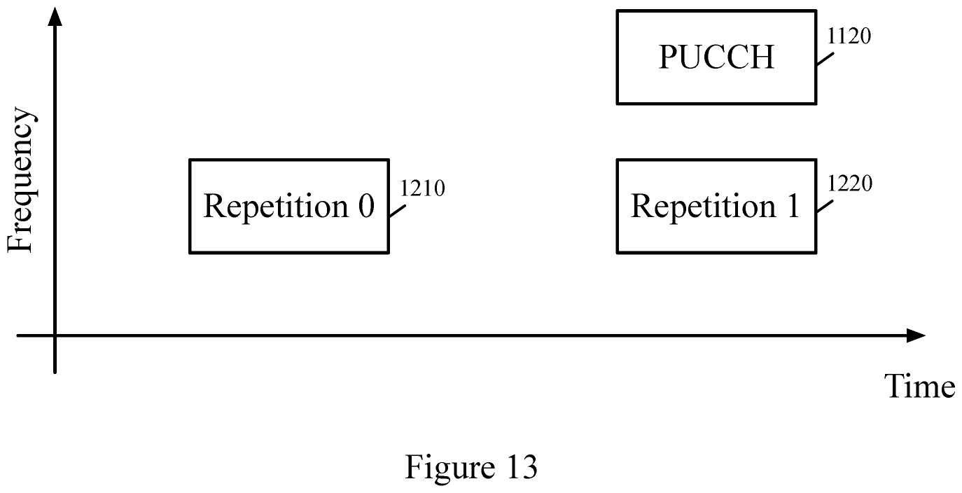

FIG. 13 is a time-frequency diagram illustrating an example of a collision of a PUCCH with at least one of the PUSCH repetitions, according to an example embodiment of the present disclosure. With reference to FIG. 13, the PUCCH 1110 may have, at least, a partial overlap with one of the PUSCH repetitions. For example, the PUCCH 1110 may have, at least, a partial overlap either with the PUSCH repetition 1220 (as shown) or the repetition 1210. As discussed above, the transmission power of a UE may be limited. Therefore, the power required for the simultaneous transmission of a PUSCH repetition and the PUCCH may exceed the transmission power of the UE. Therefore, to preserve the single carrier property, either the PUCCH or the PUSCH repetitions have to be dropped.

In a case that the OCC is not applied to the PUSCH repetitions, if the UE transmits the repetition 1210 of the PUSCH and then determines that the PUCCH 1110 overlaps the repetition 1220 of the PUSCH, the UE may drop the repetition 1220. Since the repetitions 1210 and 1220 carry the same information, the receiver is able to decode the PUSCH based on the repetition 1210 only.

Alternatively, the UE may drop the PUCCH 1110 and may piggyback the UCI 1130 that was expected to be transmitted via PUCCH 1110 on the PUSCH repetition 1120. However, in a case that the OCC is applied to the PUSCH repetitions, it is not possible to piggyback the UCI 1130 just on the PUSCH repetition 1120. As described below, in the case that the OCC is applied to the PUSCH repetitions, the PUSCH repetitions no longer carry the same information, and the receiver requires all repetitions (e.g., of a group of repetitions that carries the data associated with two or more UEs) in order to decode the PUSCH. In such a situation, adding the UCI only to one repetition changes the structure of the repetition and makes it impossible for the receiver to decode the PUSCH.

In some implementation, the OCC may be applied to the PUSCH repetitions. As an example, in a Single-Input Single-Output (SISO) system, the signal received from two UEs (e.g., UE 0 and UE 1) at the receiver may be represented as r₀=p₀₀s₀+p₁₀s₁ and r₁=p₀₁s₀+p₁₁s₁, where p₀=[p₀₀, p₀₁]^{T} and p₁=[p₁₀, p₁₁]^{T} are the pair of the OCC sequences, and T denotes the vector transpose operation. The two sequences are, therefore, orthogonal. That is, p₀₀*p′₁₀+p₀₁*p′₁₁=0. Here, p′ is the conjugate of p, and T represents the transpose of the vector, so is the transmitted data from the UE 0, and s₁ is the transmitted data from UE 1. Therefore, the transmissions from the two UEs may be multiplexed using the OCC and the time-frequency resource of the repetition 0 and repetition 1.

It is a common practice by the local governments to restrict the transmit power of the UEs per time unit. Using the OCC provides an advantage over allocating the time frequency resource of the repetition 0 to the UE 0 and allocating the time frequency resource of the repetition 1 to UE 1. The use of the OCC doubles the transmit power compared to the allocation of the time frequency resources without the OCC.

The receiver may multiply the OCC to the received signal vector r=[r₀, r₁]^{T}. For example, to extract the data so, the receiver may perform p^{H}₀*r=p′₀₀*(p₀₀s₀+p₁₀s₁)+p′₀₁*(p₀₁s₀+p₁₁s₁)=|p₀₀|²*s₀+|p₀₁|²*s₀+p′₀₀*p₁₀s₁+p′₀₁*p₁₁s₁, where p^{H}₀ denotes the conjugate of p₀. The norm of the OCC sequence may be designed to be 1. In this case, |p₀₀|²*s₀+|p₀₁|²*s₀=s₀. Furthermore, using the orthogonality of the OCC sequences, p′₀₀*p₁₀s₁+p′₀₁*p₁₁s₁=0. Therefore, p^{H}₀*r=s₀. To extract (or decode) the desired signal from the signal transmitted by the two UEs using the OCC, the receiver has to receive both repetition 0 and repetition 1.

In the following examples, it is assumed that the PUSCH transmissions for two UEs, UE 0 and UE 1, are multiplexed. For example, the OCC may be applied to the PUSCH repetitions. It is further assumed that a PUCCH transmission that is scheduled for the UE 0 collides with a repetition of the UE 0 PUSCH in the time domain. The present embodiments provide several solutions for handling the collision of the PUCCH and one of the PUSCH repetitions of the UE 0 in a case that the OCC is applied to the PUSCH repetitions.

In some embodiments, the UE 0 may stop the transmission of the PUCCH and may forego the transmission of the UCI that was expected to be transmitted by the PUCCH. In some embodiments, the UE 0 may stop the transmission of all PUSCH repetitions. In some embodiments, the UE 0 may determine that the collision occurs prior to the transmission of the first repetition of the PUSCH and may piggyback the UCI that was expected to be transmitted using the PUCCH on all PUSCH repetitions.

a. Dropping the PUCCH and Foregoing the Transmission of the UCI

In some embodiments, in a case that the OCC is applied to the PUSCH repetitions, the UE 0 may determine whether the PUCCH collides with one of the PUSCH repetitions. If the UE 0 determines that the PUCCH collides with one of the PUSCH repetition, the UE 0 may stop the PUCCH transmission. The UE 0 may further forego transmitting the UCI that was expected to be transmitted with the PUCCH.

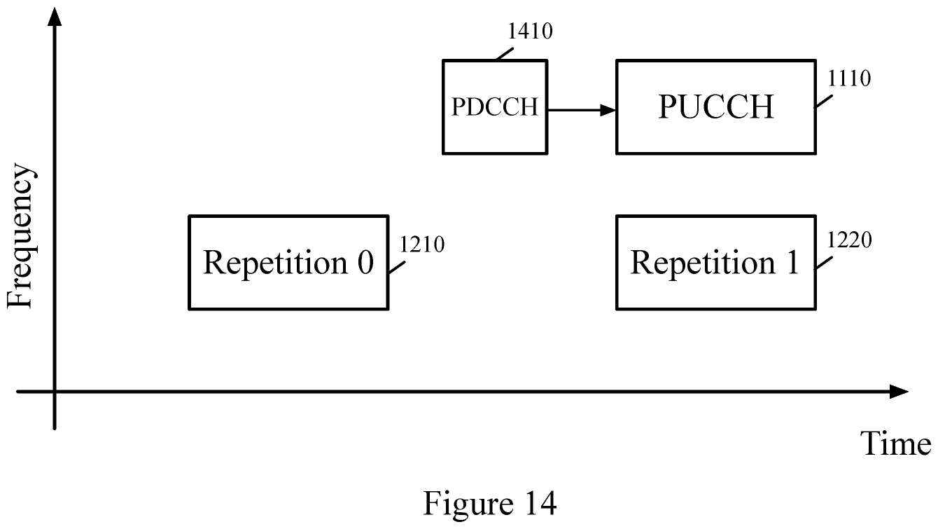

FIG. 14 is a time-frequency diagram illustrating an example of the collision of a PUCCH 1110 with a PUSCH repetition 1220 in a case that the OCC is applied to the PUSCH repetitions, according to an implementation of the present disclosure. In the example of FIG. 14, the PUCCH 1110 may be triggered by the PDCCH 1410, which may be received by the UE 0 after the repetition 1210 of the PUSCH is transmitted. After the transmission of the repetition 1210, the UE 0 may receive the PDCCH 1410. Then, the UE 0 may determine that the PUCCH 1110 collides with one repetition among multiple PUSCH repetitions.

With reference to FIG. 14, regardless of when the PDCCH 1410 is received by the UE 0 and whether the PUCCH 1110 collides with the first repetition of the PUSCH 1210 or a subsequent repetition of the PUSCH (e.g., the repetition 1220), the UE 0 does not piggyback the UCI that was expected to be transmitted with the PUCCH on the PUSCH repetitions and may simply drop the PUCCH. Therefore, none of the PUSCH repetitions are changed by the addition of the UCI, and therefore, the receiver is able to decode the PUSCH repetitions.

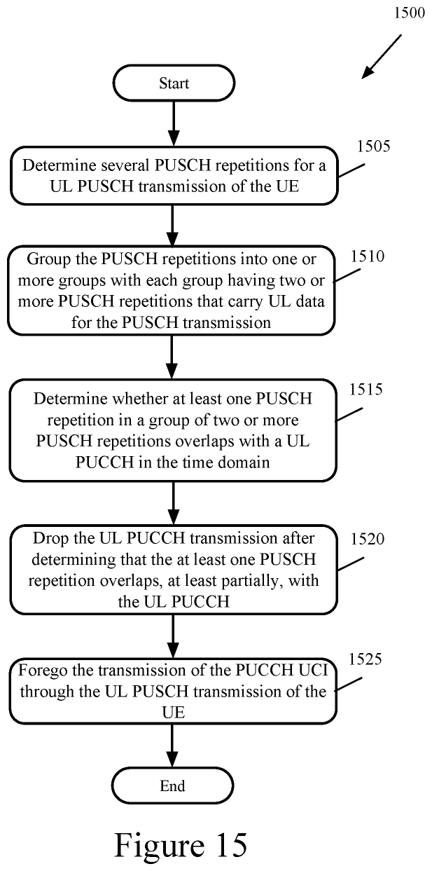

FIG. 15 is a flowchart of an example method/process 1500 performed by a UE for dropping the PUCCH and foregoing the transmission of the UCI in a case that the OCC is applied to the PUSCH repetitions and the PUCCH collides with one of the PUSCH repetitions, according to an example implementation of the present disclosure. With reference to FIG. 15, the process 1500 may be performed by at least one processor of a UE, such as one of the UEs 101A-101C (e.g., as shown in FIG. 1), or the UE 110 (e.g., as shown in FIG. 6).

The process 1500 may determine (at block 1505), several PUSCH repetitions for a UL PUSCH transmission of the UE. For example, the process 1500 may determine the PUSCH repetitions 1210-1220 of FIGS. 12-14. The UE may, for example, be configured by an RRC message from the BS (e.g., the BS 103 of FIGS. 1 and 5) to determine the PUSCH repetitions.

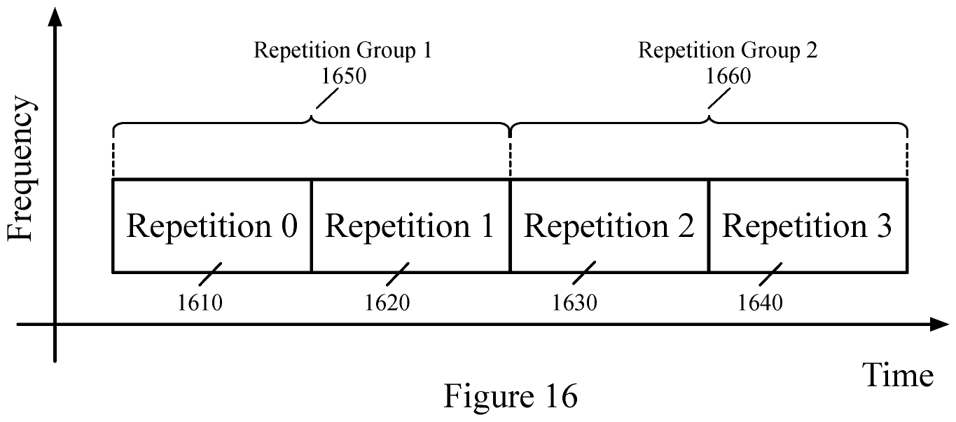

The process 1500 may group (at block 1510) the PUSCH repetitions into one or more groups with each group having two or more PUSCH repetitions that carry the UL data for the PUSCH transmission. For example, the process 1500 may group the PUSCH repetitions 1210-1220 of FIGS. 12-14 into one group of repetitions. FIG. 16 is a time-frequency diagram illustrating an example of grouping the PUSCH repetitions into several groups of repetitions, according to an example implementation of the present disclosure. With reference to FIG. 16, the PUSCH repetitions 1610-1640 may be grouped into two groups of repetitions 1650-1660. The repetition group 1650 may include the repetitions 1610 and 1620. The repetition group 1660 may include the repetitions 1630 and 1640.

The grouping of the PUSCH repetitions into one or more groups may include applying the OCC to the UL PUSCH transmission. Applying the OCC to the PUSCH transmission multiplexes the PUSCH transmission of the UE with the PUSCH transmission of one or more other UEs in the time domain. In some embodiments, the number of the repetitions in a group may be the same as the length of the OCC. For example, if the OCC length is 2, then the number of the repetitions in the group may be 2.

Referring back to FIG. 15, the process 1500 may determine (at block 1515) whether at least one PUSCH repetition in a group of two or more PUSCH repetitions overlaps with a UL PUCCH in the time domain. For example, the process 1500 may determine whether the PUCCH 1110 is, at least partially, overlapping with a repetition, such as the repetition 1220 of the PUSCH, as shown in FIG. 14.

The process 1500 may drop (at block 1520) the UL PUCCH transmission after determining that the at least one PUSCH repetition overlaps, at least partially, with the UL PUCCH. The process 1500 may forego (at block 1525) the transmission of the PUCCH UCI through the UL PUSCH transmission of the UE. The process 1500 may then end. Foregoing the transmission of the UCI that was expected to be transmitted by the PUCCH through the PUSCH repetitions guarantees that the contents of the PUSCH repetitions are not changed and the receiver is able to decode the PUSCH after receiving the repetitions.

b. Dropping all PUSCH Repetitions

In some embodiments, the transmission of the PUCCH may be prioritized over the transmission of the PUSCH repetitions in a case that the PUCCH overlaps, at least partially, one of the PUSCH repetitions. For example, some operators (e.g., the BS operators, the satellite operators, etc.) may prioritize the transmission of the control information in the PUCCH over the transmission of the data in the PUSCH repetitions.

However, when the OCC is applied, the PUSCH repetitions of UE 0 are multiplexed with the PUSCH repetitions transmitted from one or more other UEs. When the OCC is applied, the repetitions may carry different information, and the receiver (e.g., the BS or the satellite) has to receive the PUSCH repetitions (e.g., of a group) from all the UEs in order to successfully decode the PUSCH. As such, after the UE 0 transmits the first PUSCH repetition, the UE 0 cannot drop the remaining PUSCH repetitions.

The issue to consider is, in a case like the example of FIG. 14, the PUCCH 1110 is triggered by the PDCCH 1410, which is received by the UE 0 after the UE 0 has transmitted the repetition 1210. Therefore, by the time the UE 0 determines that the PUCCH collides with the repetition 1220, the UE 0 cannot stop transmission of the repetition 1210 that has been already transmitted.

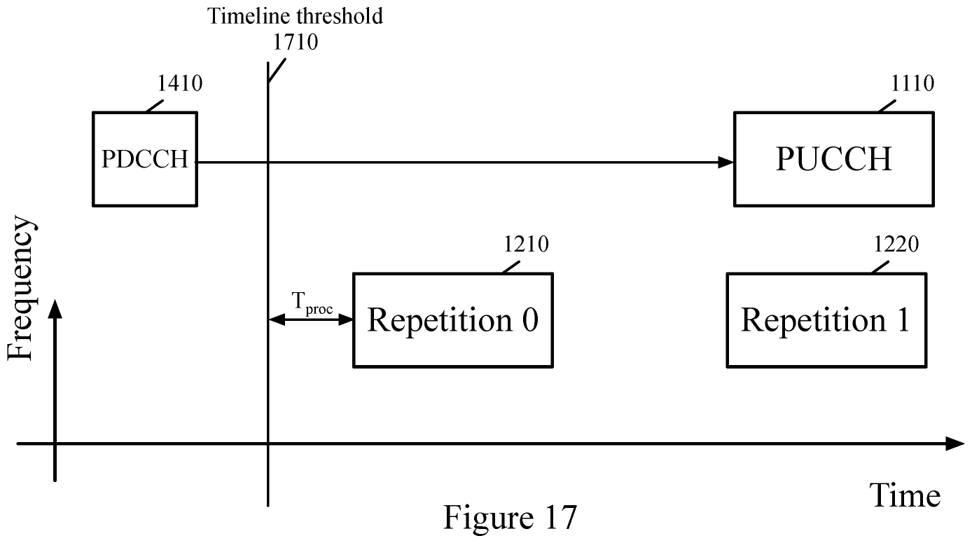

Some embodiments provide a mechanism to allow the UE to decide whether to keep or drop all repetitions of the PUSCH in case the UE determines a collision has occurred between the PUCCH and one of the PUSCH repetitions. The UE 0, in some embodiments, may be provided with a timeline threshold, as shown in FIG. 17. FIG. 17 is a time-frequency diagram illustrating an example of providing the UE with a timeline threshold 1710 to determine whether all PUSCH repetitions should be dropped in a case that the OCC is applied to the PUSCH repetitions and there is a collision between a PUCCH and one of the PUSCH repetitions, according to an example implementation of the present disclosure.

The timeline threshold 1710 may be defined as a time point which is Tproc before the first OFDM symbol of the repetition 1210. Tproc is the time required for the UE 0 to process the PDCCH 1410. With reference to FIG. 17, the UE 0 may process the PDCCH and may determine whether the PUCCH collides with one of the repetitions of the PUSCH. If the UE 0 determines that the PUCCH 1110 collides with one of the repetitions (e.g., the repletion 1220), the UE may determine whether the reception of PDCCH 1410 which triggers the PUCCH 1110 is before the timeline threshold 1710. For example, the UE 0 may determine whether the first OFDM symbol of the PDCCH 1410 that triggers the PUCCH 1110 is before the timeline threshold 1710. Alternatively, the UE 0 may determine whether the last OFDM symbol of the PDCCH 1110 that triggers the PUCCH 1110 is before the timeline threshold 1710.

If the UE 0 determines that the PDCCH 1410 that triggers the PUCCH 1110 is before the timeline threshold 1710, the UE may stop the transmission of all repetitions of the PUSCH (e.g., the repetitions 1210-1220 of the PUSCH). If the UE 0 determines that the PDCCH 1410 that triggers the PUCCH 1110 is not received before the timeline threshold 1710, the UE 0 may stop the transmission of the PUCCH 1110 (e.g., UE 0 may drop all the PUSCH repetitions).

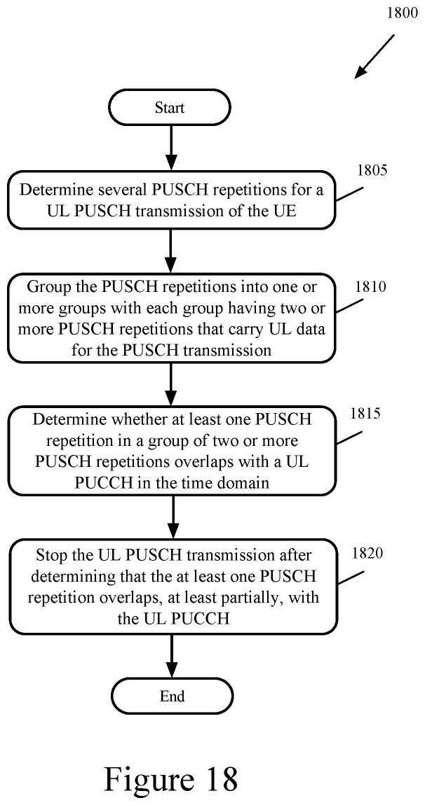

FIG. 18 is a flowchart of an example method/process 1800 performed by a UE for dropping all PUSCH repetitions in a case that the OCC is applied to the PUSCH repetitions and a PUCCH collides with one of the PUSCH repetitions, according to an example implementation of the present disclosure. With reference to FIG. 18, the process 1800 may be performed by at least one processor of a UE, such as one of the UEs 101A-101C (shown in FIG. 1), or the UE 110 (e.g., as shown in FIG. 6).

The process 1800 may determine (at block 1805), several PUSCH repetitions for a UL PUSCH transmission of the UE. For example, the process 1800 may determine the PUSCH repetitions 1210-1220 of FIG. 17. The UE may, for example, be configured by an RRC message from the BS (e.g., the BS 103 of FIGS. 1 and 5) to determine the PUSCH repetitions.

The process 1800 may group (at block 1810) the PUSCH repetitions into one or more groups with each group having two or more PUSCH repetitions that carry UL data for the PUSCH transmission (e.g., of two or more UEs). For example, the process 1800 may group the PUSCH repetitions 1210-1220 of FIGS. 12-14 into one group of repetitions. As another example, the process 1800 may group the PUSCH repetitions 1610-1640, shown in FIG. 16, into two groups of repetitions 1650-1660. All PUSCH repetitions in each group of PUSCH repetitions are required by the receiver to decode the UL data carried by the repetitions of the group as the UL data carried by the PUSCH repetitions may include first UL data for the PUSCH transmission of the UE 0 and second UL data for a second PUSCH transmission of at least one other UE. The UE 0 and the other UE(s) may transmit the first and second UL data to at least one satellite through an NTN.

The grouping of the PUSCH repetitions into one or more groups may include applying the OCC to the UL PUSCH transmission. Applying the OCC to the PUSCH transmission multiplexes the PUSCH transmission of the UE with the PUSCH transmission of one or more other UEs in the time domain. In some embodiments, the number of the repetitions in a group may be the same as the length of the OCC. For example, if the OCC length is 2, then the number of the repetitions in the group may be 2.

Referring back to FIG. 18, the process 1800 may determine (at block 1815) whether at least one PUSCH repetition in a group of two or more PUSCH repetitions overlaps with a UL physical uplink control channel (PUCCH) in the time domain. For example, the process 1800 may determine whether the PUCCH 1110 is, at least partially, overlapping with a repetition, such as the repetition 1220 of the PUSCH, as shown in FIG. 17.

The process 1800 may drop (at block 1820) the UL PUSCH transmission after determining that the at least one PUSCH repetition overlaps, at least partially, with the UL PUCCH. The process 1800 may then end.

In some embodiments, the UE may receive a PDCCH that triggers the PUCCH. After determining that at least one PUSCH repetition overlaps, at least partially, with the UL PUCCH, the process 1800 may determine whether the PDCCH is received a threshold time prior to a start of the transmission of the plurality of PUSCH repetitions. For example, the process 1800 may determine whether the PDCCH 1410 is received a time interval (e.g., Tproc) before the timeline threshold 1710, shown in FIG. 17. In a case that the PDCCH 1410 is received a time interval (e.g., Tproc) before the timeline threshold 1710, the process 1800 may stop the UL PUSCH transmission of all PUSCH repetitions 1210-1220. Otherwise, the process 1800 may stop the transmission of the PUCCH 1110.

c. Dropping the PUCCH and Piggybacking the UCI on all PUSCH Repetitions

In some embodiments, the UE 0 may first determine whether the PUCCH, at least partially, collides with one of the PUSCH repetition in a case that the OCC is applied to the PUSCH repetitions. If the UE 0 determines that the PUCCH collides with the one of the PUSCH repetitions, the UE 0 may drop the PUCCH and may piggyback the UCI that was expected to be transmitted by the PUCCH using the PUCCH on every PUSCH repetitions.

The issue to consider is, in a case like the example of FIG. 14, the PUCCH 1110 is triggered by the PDCCH 1410, which is received by the UE 0 after the UE 0 has transmitted the repetition 1210. Therefore, by the time the UE 0 determines that the PUCCH collides with the repetition 1220, the repletion 1210 is already transmitted and the UE 0 cannot piggyback the UCI on every PUSCH repetition 1210-1220.

Some embodiments provide a mechanism to allow the UE to decide whether the UE may drop the PUCCH and piggyback the UCI on every PUSCH repetition. The UE 0, in some embodiments, may be provided with a timeline threshold as shown in FIG. 17. As described above, the timeline threshold may be defined as a time point Tproc before the first (or the last) OFDM symbol of the repetition 1210. The UE 0 may first determine whether the PUCCH 1110 collides with one of the PUSCH repetitions (e.g., the repetition 1220). If the UE 0 determines that the PUCCH 1110 collides with one of the PUSCH repetitions, the UE may determine whether the PDCCH 1410 that triggers the PUCCH is before the timeline threshold 1710. For example, the UE 0 may determine whether the first OFDM symbol of the PDCCH 1410 that triggers the PUCCH 1110 is received by the UE 0 before the timeline threshold 1710. In another example, the UE 0 may determine whether the last OFDM symbol of the PDCCH 1410 which triggers the PUCCH 1110 is received by the UE 0 before the timeline threshold 1710.

If the UE determines that the PDCCH 1410 that triggers the PUCCH 1110 is before the timeline threshold 1710, the UE 0 may piggyback the UCI that was expected to be transmitted using the PUCCH 1110 on all PUSCH repetitions 1210-1220. If the UE 0 determine that the PDCCH 1410 that triggers the PUCCH 1110 is not received before the timeline threshold 1710, the UE 0 may stop the transmission of the PUCCH 1110. In such a scenario, the UE 0 may forego the transmission of the PUCCH UCI through the UL PUSCH transmission of the UE.

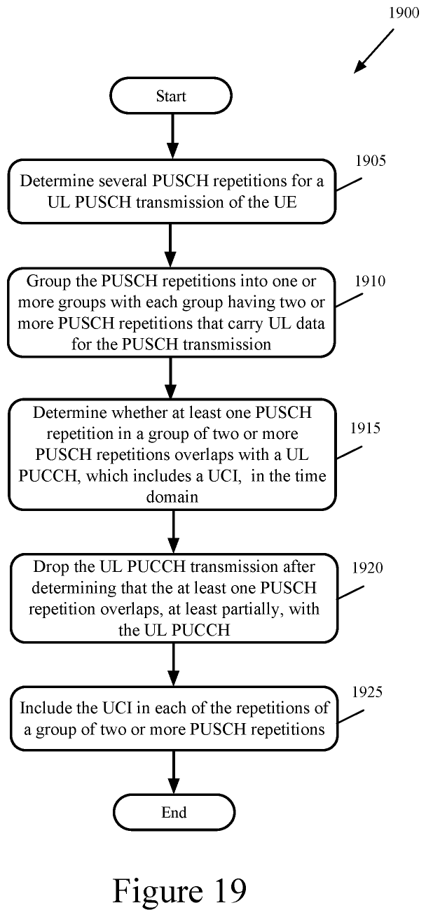

FIG. 19 is a flowchart of an example method/process 1900 performed by a UE for dropping the PUCCH and piggybacking the transmission of the UCI of the PUCCH on the PUSCH repetitions in a case that the OCC is applied to the PUSCH repetitions and the PUCCH collides with one of the PUSCH repetitions, according to an example implementation of the present disclosure. With reference to FIG. 19, the process 1900 may be performed by at least one processor of a UE, such as one of the UEs 101A-101C (shown in FIG. 1), or the UE 110 (shown in FIG. 6).

The process 1900 may determine (at block 1905), several PUSCH repetitions for a UL PUSCH transmission of the UE. For example, the process 1900 may determine the PUSCH repetitions 1210-1220 of FIGS. 12-14. The UE may, for example, be configured by an RRC message from the BS (e.g., the BS 103 of FIGS. 1 and 5) to determine the PUSCH repetitions.

The process 1900 may group (at block 1910) the PUSCH repetitions into one or more groups with each group having two or more PUSCH repetitions that carry UL data for the PUSCH transmission. For example, the process 1900 may group the PUSCH repetitions 1210-1220 of FIGS. 12-14 into one group of repetitions. As another example, the process 1800 may group the PUSCH repetitions 1610-1640 into two groups of repetitions 1650-1660, as shown in FIG. 16. All PUSCH repetitions in each group of PUSCH repetitions are required by the receiver to decode the UL data carried by the repetitions of the group as the UL data carried by the PUSCH repetitions may include first UL data for the PUSCH transmission of the UE 0 and second UL data for a second PUSCH transmission of at least one other UE. The UE 0 and the other UE(s) may transmit the first and second UL data to at least one satellite through an NTN.

The grouping of the PUSCH repetitions into one or more groups may include applying OCC to the UL PUSCH transmission. Applying the OCC to the PUSCH transmission multiplexes the PUSCH transmission of the UE with the PUSCH transmission of one or more other UEs in the time domain. In some embodiments, the number of the repetitions in a group may be the same as the length of the OCC. For example, if the OCC length is 2, then the number of the repetitions in the group may be 2.

Referring back to FIG. 19, the process 1900 may determine (at block 1915) whether at least one PUSCH repetition in a group of two or more PUSCH repetitions overlaps with a UL PUCCH, which includes a UCI, in the time domain. For example, the process 1900 may determine whether the PUCCH 1110 is, at least partially, overlapping with a repetition, such as the repetition 1220 of the PUSCH, as shown in FIG. 17.

The process 1900 may drop (at block 1920) the UL PUCCH transmission after determining that the at least one PUSCH repetition overlaps, at least partially, with the UL PUCCH. The process 1900 may piggyback (at block 1925) the UCI that was expected to be transmitted with the PUCCH in each of the repetitions of a group of two or more PUSCH repetitions. The process 1900 may then end. Piggybacking the UCI that was expected to be transmitted by the PUCCH on every repetition of the PUSCH guarantees that the contents of the PUSCH repetitions are not changed after the transmission of one or more PUSCH repetitions, and the receiver is able to decode the PUSCH after receiving the repetitions.

In some embodiments, the UE may receive a PDCCH that triggers the PUCCH. After determining that at least one PUSCH repetition overlaps, at least partially, with the UL PUCCH, the process 1900 may determine whether the PDCCH is received a threshold time prior to a start of the transmission of the plurality of PUSCH repetitions. For example, the process 1900 may determine whether the PDCCH 1410 is received a time interval (e.g., Tproc) before the timeline threshold 1710, shown in FIG. 17. In a case that the PDCCH 1410 is received a time interval (e.g., Tproc) before the timeline threshold 1710, the process 1800 may piggyback the UCI on every PUSCH repetitions 1210-1220. Otherwise, the process 1900 may stop the transmission of the PUCCH 1110 and may forego the transmission of the UCI through the UL PUSCH transmission of the UE.

II. Handling UL Transmission Collisions when OCC is Applied

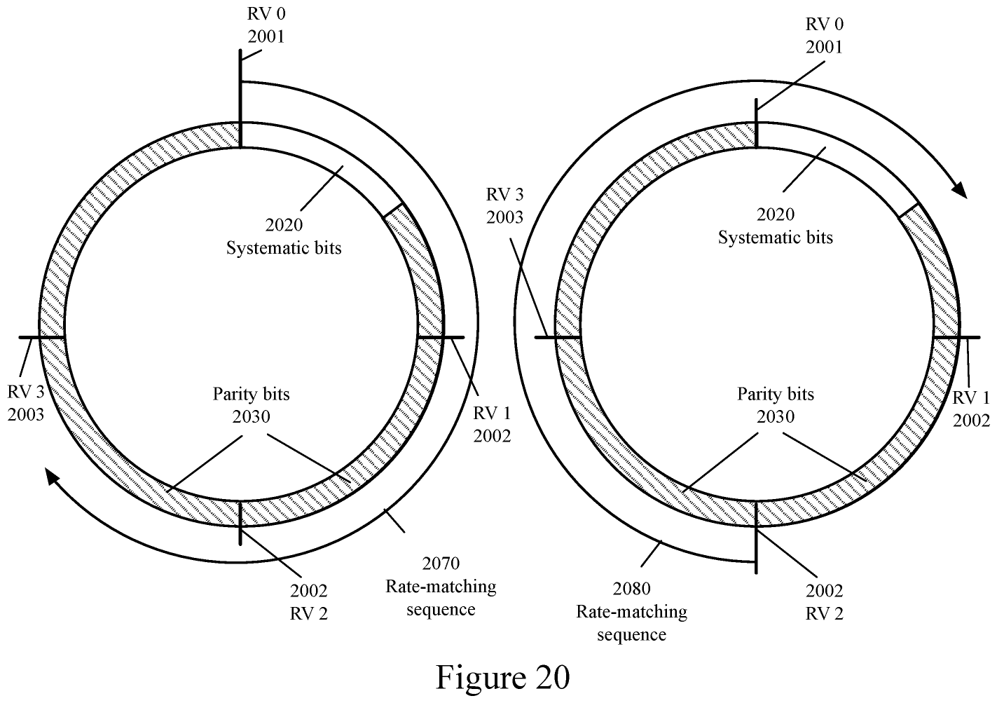

In some embodiments, a redundancy version (RV) from a sequence of RVs may be mapped to each PUSCH repetition. From coding gain, different RVs should be mapped to different PUSCH repetitions. Using different RVs for repetitions ensures sending as many parity bits as possible. FIG. 20 is a diagram illustrating an example of a circular buffer for rate-matching operation, according to an example implementation of the present disclosure.

Circular buffers are a concept which may store coded bits. The coded bits may be divided into the systematic bits 2020 and the parity bits 2030. One example of systematic bits is the information bits carried by a PUSCH repetition. In this example, the systematic bits 2020 may be uncoded bits. The systematic bits 2020 are essential to decode.

The parity bits 2030 are bits to aid coding gain to the information bits. The parity bits may be used for error detection. The parity bits are not essential to decode. On the other hand, the coding gain is larger if more parity bits are transmitted.

The RV is a reference point of the rate-matching sequence generation. The rate-matcher of the UE may read the circular buffer from the coded bit determined by the provided RV and may generate a rate-match sequence 2070 or 2080. Typically, the rate-matcher may read only some part of the circular buffer, as shown in FIG. 20. Therefore, different RVs may be mapped to different PUSCH repetitions, which may diversify the rate-matching sequence.

The RV sequences, in some embodiments, may be used to map RVs to the PUSCH repetitions. For example, the RV sequence {0, 2, 3, 1} may be defined. If a PUSCH with 4 repetitions applies the RV sequence {0, 2, 3, 1} and the OCC is not applied to the PUSCH repetitions, the RV0 2001 may be mapped to the 1^{st} PUSCH repetition, the RV2 2002 may be mapped to the 2^{nd} PUSCH repetition, the RV3 2003 may be mapped to the 3^{rd} PUSCH repetition, and RV1 2001 may be mapped to the 4^{th} PUSCH repetition. However, when OCC is applied to the PUSCH repetitions, the RV should be the same within a repetition group. Otherwise, the OCC may not work due to the different physical structure. Therefore, for PUSCH repetitions with the OCC, a new RV sequence should be defined.

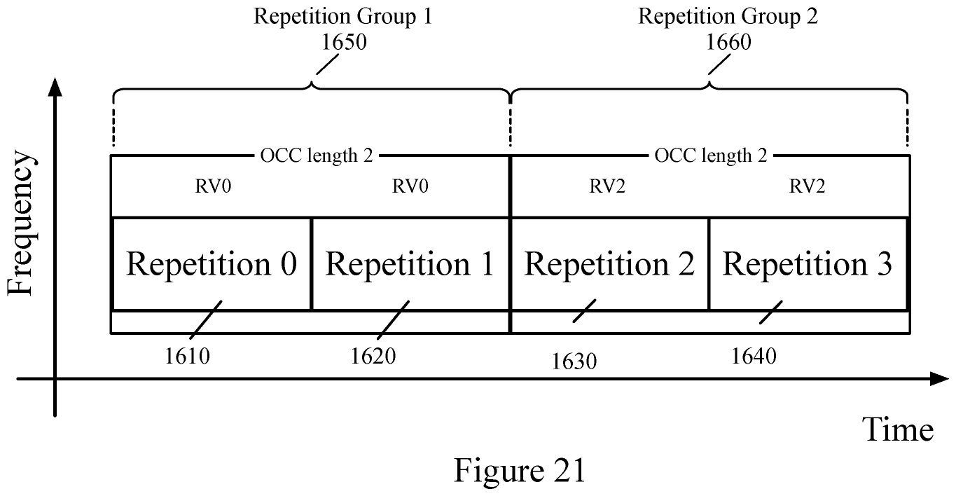

FIG. 21 is a time-frequency diagram illustrating an example of grouping the PUSCH repetitions into several groups of repetitions and mapping the RVs to the repetitions, according to an example implementation of the present disclosure. In FIG. 21, four PUSCH repetitions 1610-1640 may be placed in the time-frequency resource. In the example of FIG. 21, an OCC with the length of 2 may be applied to the repetitions 1610-1620 and the repetitions 1630-1640. A set of repetitions grouped by the OCC is also referred to as repetition group. In the example of FIG. 21, the repetitions 1610-1620 form a repetition group 1650, and the repetitions 1630-1640 forms another repetition group 1660.

In some embodiments, the RV sequence may be expanded by the length of OCC. For example, RV sequence {0, 2, 3, 1} may be expanded by 2, resulting in {0, 0, 2, 2, 3, 3, 1, 1}. In another example, RV sequence {0, 2, 3, 1} may be expanded by 4, resulting in {0, 0, 0, 0, 2, 2, 2, 2, 3, 3, 3, 3, 1, 1, 1, 1}. For example, RV sequence {0, 0, 2, 2} may be expanded by 2, resulting in {0, 0, 0, 0, 2, 2, 2, 2}.

The UE 0 may determine whether the OCC is applied to the PUSCH repetitions. If the OCC is applied to the PUSCH repetitions, the UE may use the expanded RV sequence to map the RVs to the repetitions. If the OCC is not applied to the PUSCH repetitions, the UE may use the unexpanded RV sequence to map the RVs to the PUSCH repetitions. The UE, in some embodiments, may expand the RV sequence by the length of OCC that is applied to the PUSCH. In some embodiments, the UE may use an expanded RV sequence that is indicated or configured by the BS. for example, the BS may indicate or configure the expanded RV sequence to the UE by an RRC message.

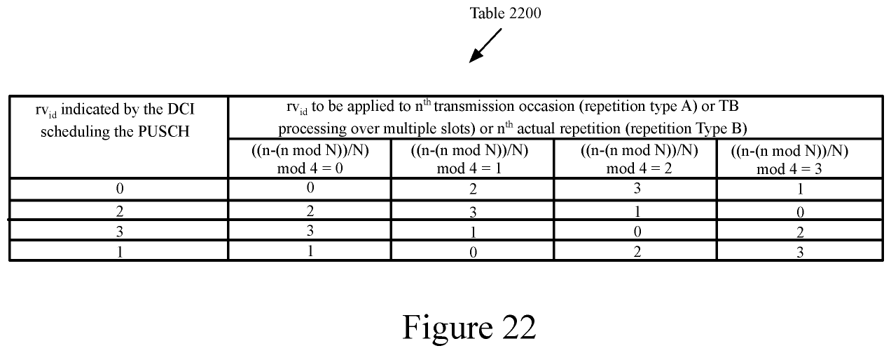

FIG. 22 is an example diagram illustrating a table 2100 that defines the RV allocation for the n^{th} PUSCH repetition, according to an implementation of the present disclosure. With reference to FIG. 22, the RV allocation, in some embodiments, may be performed using a formula shown in the table 2200. The table 2200 defines RV allocation for the n^{th} PUSCH repetition. In the table, the n^{th} PUSCH transmission occasion is denoted as n^{th} transmission occasion. For example, if rv_{id} indicated by the DCI format used for scheduling the PUSCH is 0, the RV sequence of {0, 2, 3, 1} may be used. The parameter N may then be used to expand the RV sequence. For example, in a case of N=2, if n=0 or 1, ((n−(n mod N))/N) mod 4=0. Therefore, the RV0 may be allocated to the 0^{th} and 1^{st} PUSCH repetition (e.g., the PUSCH repetitions 1610 and 1620 shown in FIG. 21).

If n=2 or 3, ((n−(n mod N))/N) mod 4=1. Therefore, the RV2 may be allocated. For If n=4 or 5, ((n−(n mod N))/N) mod 4=2. Therefore, the RV3 may be allocated. If n=6 or 7, ((n−(n mod N))/N) mod 4=3. Therefore, the RV3 is allocated. Thus, using ((n−(n mod N))/N) mod 4 while setting the value of N to the length of OCC may be used to expand the RV sequence. Here, the parameter N was used to scale up TBS for the PUSCH. On the other hand, in some embodiments, TBS scaling may not be applied to the PUSCH if N is set to the length of OCC. In some embodiments, the RRC parameter may be used to configure whether N is used to scale up the TBS.

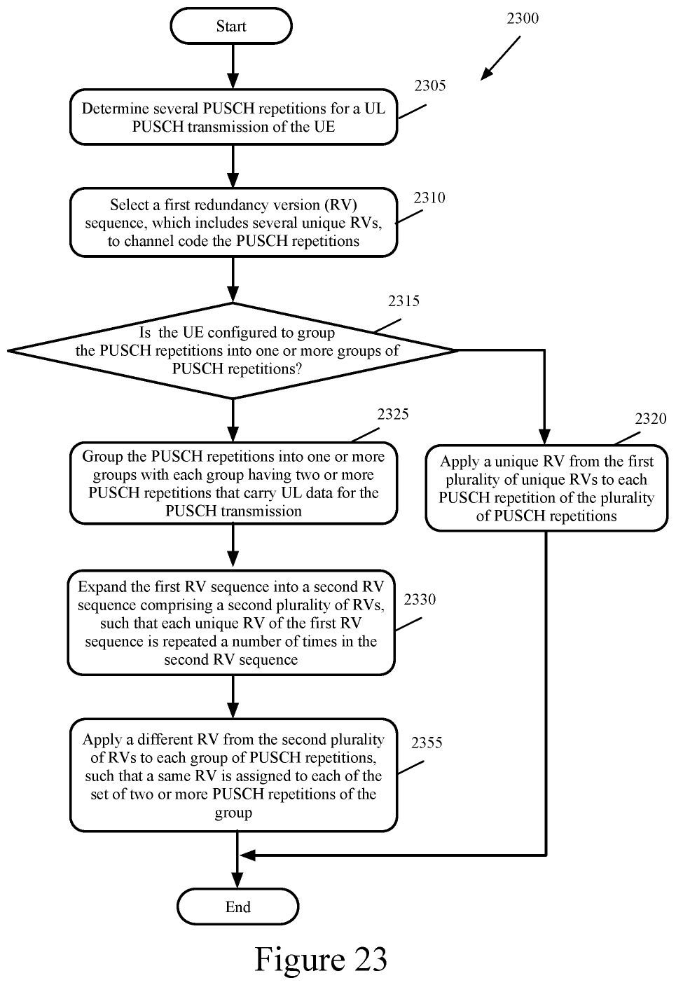

FIG. 23 is a flowchart of an example method/process 2300 performed by a UE for channel coding of PUSCH, according to an example implementation of the present disclosure. With reference to FIG. 23, the process 2300 may be performed by at least one processor of a UE, such as one of the UEs 101A-101C (shown in FIG. 1), or the UE 110 (shown in FIG. 6).

The process 2300 may determine (at block 2305), several PUSCH repetitions for a UL PUSCH transmission of the UE. For example, the process 2300 may determine the PUSCH repetitions 1210-1220 of FIGS. 12-14. The UE may, for example, be configured by an RRC message from the BS (e.g., the BS 103 of FIGS. 1 and 5) to determine the PUSCH repetitions.

The process 2300 may select (at block 2310) a first RV sequence, which may include several RVs, to channel code the PUSCH repetitions. For example, the process 2300 may select the RV sequence {0, 2, 3, 1}, as described above. The process 2300 may make a determination as to whether the UE is configured to group the PUSCH repetitions into one or more groups of PUSCH repetitions.

In a case that the UE is not configured to group the PUSCH repetitions into one or more groups of PUSCH repetitions, the process 2300 may apply (at block 2320) a unique RV from the unique RVs of the sequence to each PUSCH repetition of the PUSCH repetitions. For example, when the PUSCH includes 4 repetitions, the RV0 2001 shown in FIG. 20 may be mapped to the 1^{st} PUSCH repetition, the RV2 2002 may be mapped to the 2^{nd} PUSCH repetition, the RV3 2003 may be mapped to the 3^{rd} PUSCH repetition, and RV1 2001 may be mapped to the 4^{th} PUSCH repetition. The process 2300 may then end.

In a case that the UE is configured to group the PUSCH repetitions into one or more groups of PUSCH repetitions, the process 2300 group (at block 2325) the PUSCH repetitions into one or more groups with each group having two or more PUSCH repetitions that carry UL data for the PUSCH transmission. For example, the process 2300 may group the PUSCH repetitions 1210-1220 of FIGS. 12-14 into one group of repetitions. As another example, the process 2300 may group the PUSCH repetitions 1610-1640 into two groups of repetitions 1650-1660, as shown in FIG. 16. All PUSCH repetitions in each group of PUSCH repetitions are required by the receiver to decode the UL data carried by the repetitions of the group as the UL data carried by the PUSCH repetitions may include first UL data for the PUSCH transmission of the UE 0 and second UL data for a second PUSCH transmission of at least one other UE. The UE 0 and the other UE(s) may transmit the first and second UL data to at least one satellite through an NTN.

The grouping of the PUSCH repetitions into one or more groups may include applying OCC to the UL PUSCH transmission. Applying the OCC to the PUSCH transmission multiplexes the PUSCH transmission of the UE with the PUSCH transmission of one or more other UEs in the time domain. In some embodiments, the number of the repetitions in a group may be the same as the length of the OCC. For example, if the OCC length is 2, then the number of the repetitions in the group may be 2.

Referring back to FIG. 23, the process 2300 may expand (at block 2330) the first RV sequence into a second RV sequence that may include several RVs such that each unique RV of the first RV sequence is repeated a number of times in the second RV sequence. The number of times that each unique RV of the first RV sequence is repeated in the second RV sequence is based on an RRC message received from BS.

The process 2300 may apply (at block 2355) a different RV from the RVs of the second RV sequence to each group of PUSCH repetitions, such that the same RV is assigned to each of the set of two or more PUSCH repetitions of the group. The process 2300 may then end.

In some embodiments, at least one RV in each of the first and second RV sequences may include the systematic bits that carry the UL PUSCH data. In some embodiments, at least one RV in each of the first and second RV sequences may include several parity bits to provide reliability for decoding the PUSCH transmission by a receiver.

Some embodiments may store several coded bits in a circular buffer to perform rate matching operation. In the case that the UE is not configured to group the plurality of PUSCH repetitions, the process 2300 may further assign the coded bits in at least a portion of the circular buffer to the RVs of the first RV sequence. The process 2300 may then write the codded bits in the portion of the circular buffer that is assigned to the first RV sequence to the output sequence of the rate-matching operation. The size of the circular buffer and the length of the output sequence of the rate-matching operation may determine the number of parity bits written in the output sequence of the rate-matching operation.

Some embodiments may store several coded bits in a circular buffer to perform rate matching operation. In the case that the UE is configured to group the plurality of PUSCH repetitions, the process 2300 may further assign the coded bits in at least a portion of the circular buffer to the RVs of the second RV sequence. The process 2300 may then write the codded bits in the portion of the circular buffer that is assigned to the second RV sequence to the output sequence of the rate-matching operation. The size of the circular buffer and the length of the output sequence of the rate-matching operation may determine the number of parity bits written in the output sequence of the rate-matching operation.

The various foregoing example embodiments and modes may be utilized in conjunction with one another, e.g., in combination with one another.

Each of a program running on the BS and the terminal device 101A-101C according to an aspect of the present invention may be a program that controls a Central Processing Unit (CPU) and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

Note that the terminal device 101A-101C and the base station device 103 according to the above-described embodiment may be partially achieved by a computer. In this case, this configuration may be realized by recording a program for realizing such control functions on a computer-readable recording medium and causing a computer system to read the program recorded on the recording medium for execution.

Note that it is assumed that the “computer system” mentioned here refers to a computer system built into the terminal device 101A-101C or the base station device 103, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the base station device 103 according to the above-described embodiment may be achieved as an aggregation (a device group) including multiple devices. Each of the devices configuring such a device group may include some or all of the functions or the functional blocks of the base station device 103 according to the above-described embodiment. The device group may include each general function or each functional block of the base station device 103. Furthermore, the terminal device 101A-101C according to the above-described embodiment can also communicate with the base station device as the aggregation.

Furthermore, the base station device 103 according to the above-described embodiment may serve as an Evolved Universal Terrestrial Radio Access Network (E-UTRAN) and/or NG-RAN (Next Gen RAN, NR-RAN). Furthermore, the base station device 103 according to the above-described embodiment may have some or all of the functions of a node higher than an eNodeB or the gNB.

Furthermore, some or all portions of each of the terminal device 101A-101C and the base station device 103 according to the above-described embodiment may be typically achieved as an LSI which is an integrated circuit or may be achieved as a chip set. The functional blocks of each of the terminal device 101A-101C and the base station device 103 may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device 101A-101C has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for channel coding of physical uplink shared channel (PUSCH); and
at least one processor coupled to the one or more non-transitory computer-readable media, and configured to execute the one or more computer-executable instructions to cause the UE to:
determine a plurality of PUSCH repetitions for an uplink (UL) PUSCH transmission of the UE;
select a first redundancy version (RV) sequence to channel code the plurality of PUSCH repetitions, the first RV sequence comprising a first plurality of unique RVs;
determine whether the UE is configured to group the plurality of PUSCH repetitions into one or more groups of PUSCH repetitions;
in a case that the UE is not configured to group the plurality of PUSCH repetitions, apply a unique RV from the first plurality of unique RVs to each PUSCH repetition of the plurality of PUSCH repetitions; and
in a case that the UE is configured to group the plurality of PUSCH repetitions:
group the plurality of PUSCH repetitions into one or more groups of PUSCH repetitions, each group of PUSCH repetitions comprising a set of two or more PUSCH repetitions,
expand the first RV sequence into a second RV sequence comprising a second plurality of RVs, wherein each unique RV of the first RV sequence is repeated a number of times in the second RV sequence, and
apply a different RV from the second plurality of RVs to each group of PUSCH repetitions, such that a same RV is assigned to each of the set of two or more PUSCH repetitions of the group.

2. The UE of claim 1, wherein the number of times that each unique RV of the first RV sequence is repeated in the second RV sequence is based on a radio resource control (RRC) message received from a base station (BS).

3. The UE of claim 1, wherein grouping the plurality of PUSCH repetitions into one or more groups comprises:
applying orthogonal cover code (OCC) to the UL PUSCH transmission.

4. The UE of claim 3, wherein the number of times that each unique RV of the first RV sequence is repeated in the second RV sequence is based on a length of the OCC.

5. The UE of claim 3, wherein applying the OCC to the PUSCH transmission multiplexes the PUSCH transmission of the UE with a PUSCH transmission of one or more other UEs in time domain.

6. The UE of claim 1, wherein all PUSCH repetitions in each set of two or more PUSCH repetitions are required by a receiver to decode UL data carried by the set of two or more PUSCH repetitions.

7. The UE of claim 6, wherein the UL data carried by the set of two or more PUSCH repetitions comprises first UL data for the PUSCH transmission of the UE and second UL data for a second PUSCH transmission of at least one other UE.

8. The UE of claim 7, wherein the UE and the at least one other UE transmit the first and second UL data to at least one satellite through a non-terrestrial network (NTN).

9. The UE of claim 1, wherein at least one RV in each of the first and second RV sequences comprises a plurality of systematic bits carrying UL PUSCH data.

10. The UE of claim 1, wherein at least one RV in each of the first and second RV sequences comprises a plurality of parity bits to provide reliability for decoding the PUSCH transmission by a receiver.

11. The UE of claim 1, wherein the at least one processor is configured to execute the one or more computer-executable instructions to cause the UE to:
store a plurality of coded bits in a circular buffer to perform a rate matching operation; and
in the case that the UE is not configured to group the plurality of PUSCH repetitions, further:
assign the coded bits in at least a portion of the circular buffer to the first plurality of RVs, and
write the codded bits in the portion of the circular buffer that is assigned to the first RV sequence to an output sequence of the rate-matching operation.

12. The UE of claim 11, wherein a size of the circular buffer and a length of the output sequence of the rate-matching operation determine a number of parity bits written in the output sequence of the rate-matching operation.

13. The UE of claim 1, wherein the at least one processor is configured to execute the one or more computer-executable instructions to cause the UE to:
store a plurality of coded bits in a circular buffer to perform a rate matching operation; and
in the case that the UE is configured to group the plurality of PUSCH repetitions, further:
assign the coded bits in at least a portion of the circular buffer to the second plurality of RVs, and
write the codded bits in the portion of the circular buffer that is assigned to the second RV sequence to an output sequence of the rate-matching operation.

14. The UE of claim 13, wherein a size of the circular buffer and a length of the output sequence of the rate-matching operation determine a number of parity bits written in the output sequence of the rate-matching operation.

15. A method of channel coding of physical uplink shared channel (PUSCH), the method comprising:
determining a plurality of PUSCH repetitions for an uplink (UL) PUSCH transmission of the UE;
selecting a first redundancy version (RV) sequence to channel code the plurality of PUSCH repetitions, the first RV sequence comprising a first plurality of unique RVs;
determining whether the UE is configured to group the plurality of PUSCH repetitions into one or more groups of PUSCH repetitions;
in a case that the UE is not configured to group the plurality of PUSCH repetitions, applying a unique RV from the first plurality of unique RVs to each PUSCH repetition of the plurality of PUSCH repetitions; and
in a case that the UE is configured to group the plurality of PUSCH repetitions:
grouping the plurality of PUSCH repetitions into one or more groups of PUSCH repetitions, each group of PUSCH repetitions comprising a set of two or more PUSCH repetitions,
expanding the first RV sequence into a second RV sequence comprising a second plurality of RVs, wherein each unique RV of the first RV sequence is repeated a number of times in the second RV sequence, and
applying a different RV from the second plurality of RVs to each group of PUSCH repetitions, such that a same RV is assigned to each of the set of two or more PUSCH repetitions of the group.
